(19) United States
(12) Patent Application Publication
(10) Pub. No.: US 2005/0148705 A1
(43) Pub. Date: Jul. 7, 2005

(54) Weatherfast pigmented polystyrene

(76) Inventors: John W. Adams, The Woodlands, TX (US); Roger Reinicker, Hockessin, DE (US); Justin Lankford White, Chestertown, MD (US); Gerald A. Capocci, Greenwich, CT (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/990,578

(22) Filed: Nov. 17, 2004

Related U.S. Application Data
(60) Provisional application No. 60/524,230, filed on Nov. 21, 2003.

(51) Int. Cl. C08K 5/34; C08K 3/04

(52) U.S. Cl. 524/100; 524/495

(57) ABSTRACT

The invention is directed to weatherable pigmented extruded polystyrene molded or extruded foam articles for use in outdoor applications or applications which require high weatherfastness. The weatherfast pigmented polystryene compositions can be prepared by incorporating by extrusion or molding (a) a foam polystyrene homopolymer or copolymer (b) at least one compound selected from an light absorber, (c) at least one compound selected from the group consisting of low molecular weight hindered amine light stabilizer, (d) at least one compound selected from the group consisting of high molecular weight hindered amine light stabilizer, (e) at least one pigment and (f) optionally carbon black, wherein the expanded polymer foam shows a Δ E color change under xenon weathering over a period of 3000 hours of less than about 3.0.

This application claims the benefit of U.S. Provisional application No. 60/524,230, filed Nov. 21, 2003.

The invention relates to weatherable pigmented polystyrene molded or extruded foam articles for use in outdoor applications or applications which require high weatherfastness.

### BACKGROUND OF THE INVENTION

Extruded or molded polystyrene foams are widely used to insulate buildings, as components of buildings, siding, and window trim. However, styrenic polymers such as ABS and polystyrenes impact-modified with polybutadiene are very sensitive to oxidation. Degradation on weathering starts at the surface and results in fast loss of mechanical properties such as impact strength. Because of this sensitivity to oxidation, polystyrene is normally not used in outdoor applications where there is direct exposure to weathering unless protected by pigmented and/or UV-stabilized polyacrylate films or the addition of relatively large amounts of carbon black.

These known methods of improving the aging resistance are not only inadequate but also suffer from technical disadvantages. Thus, laminating with protective films is only possible in the case of sheets, which, for example, are further converted by the deep-drawing process, and is not applicable to injection moldings. Surface protection by lacquering requires an additional processing step, which increases the costs and does not always give adequate long term weatherfastness.

Accordingly, the inventors have surprisingly discovered that it is possible to make lasting weatherfast pigmented polystyrene compositions which do not require the application of protective acrylic resin lacquer topcoats or the addition of relatively large amounts of carbon black.

It is known to use light absorbers of the 2-(2′-hydroxyphenyl) benzotriazole type in polystyrene. It is also known to use sterically hindered amines and benzotriazole light absorber combinations and that these combinations yield good performance even in outdoor exposure of crystal polystyrene. See Plastics Additive Handbook, 4^{th} edition, ed. By R. Gächter et.al, 1993, pp.237-241 and Better Light Stability for Styrenic Polymers, by J. Geil et al in Modern Plastics, September 1983.

U.S. Pat. No. 4,692,486 shows synergistic mixtures of low-molecular and high-molecular polyalkylpiperidines for protection of polystyrene.

U.S. Pat. No. 4,110,304 discloses and claims the use of hindered amines in combination with co-stabilizers such as benzophenones and benzotriazoles.

U.S. Pat. No. 5,492,948 discloses a stablizer system for styrene polymers which comprises a benzotriazole and an oligomeric condensate of N,N′-(2,2,6,6-tetramethylpiperidyl) hexamethylene diamine and 2,4-dichloro-6-morpholino-1,3,5-s-triazine and tris(3,5-di-tert-butyl-4-hydroxybenzyl) isocyanurate.

WO2000-069956 application discloses compositions comprising a hydrogenated polystyrene in combination with a hindered amine and an light absorber which can be used for outdoor exposure applications.

GB 2328213 patent application discloses a paint composition suitable for high temperatures using the pigment combination of bismuth vanadate (BiVO₄) and ferric (III) oxide (Fe₂O₃).

Surprisingly, the inventors have found that compositions combining light absorber stabilizers with hindered amine stabilizers (HALS) with select pigments give highly stable compositions for extruded or molded foamed polystyrene. This inventive solution does not require the application of protective acrylic resin lacquer topcoats or the addition of relatively large amounts of carbon black thus avoiding the cost associated with the extra step. Furthermore, the invention allows uses of colors other than carbon black to give weatherfast pigmented polystyrene foam which can be easily made by simple extrusion or molding.

### DETAILED DESCRIPTION OF THE INVENTION

It is an object of the present invention to provide compositions of extruded or molded pigmented polystyrene foams that retain their color when exposed to the influences of sunlight, heat and outdoor weathering.

Accordingly, disclosed is

A pigmented polystyrene foam composition comprising
(a) a foam polystyrene homopolymer or copolymer,
(b) at least one compound selected from the group consisting of light absorbers,
(c) at least one low molecular weight hindered amine light stabilizer,
(d) at least one high molecular weight hindered amine light stabilizer,
(e) at least one pigment and
(f) optionally, carbon black,
   wherein the expanded polymer foam shows a Δ E color change when exposed under an Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0, wherein Δ E color change is determined according to ASTM method D2244.

Preferably a Δ E color change of less than about 2.5, and most preferably Δ E color change of less than about 1.5 , wherein Δ E color change is determined as above.

Further, it is an object of the present invention to provide a method of protecting pigmented molded foam polystyrene from discoloration when exposed to the influences of sunlight, heat and outdoor weathering.

Accordingly, disclosed is

A method of protecting pigmented polystyrene foam from discoloration when exposed to the influences of outdoor weathering comprising the steps of:
(i) expressing a styrenic polymer or copolymer gel composition from a die so that the expressed gel expands into a cellular foam by the action of a blowing agent, said gel composition comprising
   (a) a polystyrene homopolymer or copolymer
   (b) at least one light absorber,
   (c) at least one low molecular weight hindered amine light stabilizers,
   (d) at least one high molecular weight hindered amine light stabilizer,
   (e) at least one pigment and
   (f) optionally, carbon black
and,
(ii) cooling the expanded polymer foam to a temperature at which said foam is self-supporting,
wherein the expanded polymer foam shows a Δ E color change when exposed under an Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0 , wherein Δ E color change is determined according to ASTM method D2244.

Preferably a Δ E color change of less than about 2.5, and most preferably Δ E color change of less than about 1.5 , wherein Δ E color change is determined as above.

Further it is an object of the invention to provide an additive combination for pigmenting polystyrene foam comprising components (b) thru (f), wherein the additive combination incorporated into expanded polystyrene foam shows a Δ E color change when exposed under a Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0, preferably a Δ E color change of less than about 2.5, and most preferably Δ E color change of less than about 1.5, wherein Δ E color change is determined according to ASTM method D2244.

Further it is an object of the invention to provide a molded or extruded polystyrene foam article comprising components (b) thru (f), wherein the expanded polymer foam shows a Δ E color change under when exposed under an Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0, preferably a Δ E color change of less than about 2.5, and most preferably Δ E color change of less than about 1.5, wherein Δ E color change is determined according to ASTM method D2244.

Suitable Styrenic Polymers of Component (a)

Styrenic polymers are usually classified as general-purpose polystyrene (GPPS) or as impact-modified polystyrene (IPS). GPPS is a high molecular weight, clear polymer which is hard, rigid and free of odor and taste. It finds use in producing moldings and extrusions, including foams and films. IPS is a rubber-modified polystyrene which is characterized by its toughness and resistance to abuse. The rubber, such as a butadiene rubber, is dispersed in the polystyrene matrix in the form of discrete particles. IPS is not clear, but rather is either translucent or opaque depending upon the amount of rubber used. The art recognizes two types of IPS, i.e., medium-impact polystyrene (MIPS) and high-impact polystyrene (HIPS), the former containing less rubber than the latter. HIPS can be generally characterized as having about an 8 to about 18 wt % rubber content. In some instances, mixtures of IPS and GPPS are used to achieve certain blends of properties.

For the purposes of this invention, the styrenic polymer can be GPPS, or a mixture of GPPS and IPS. The GPPS and IPS may be homopolymers, copolymers or block polymers and are formed from such vinyl aromatic monomers as styrene, ring-substituted methyl or polymethylstyrenes, ring-substituted ethyl or polyethylstyrenes, ring-substituted propyl or polypropylstyrenes, ring-substituted butyl or polybutyl styrenes, ring-substituted mixed polyalkylstyrenes wherein the alkyl groups differ from each other, alpha-methylstyrene, ring-substituted methyl- or polymethyl-alpha-methylstyrenes, propyl- or polypropyl-alpha-methyl-styrenes, butyl- or polybutyl-alpha-methylstyrenes, ring-substituted mixed polyalkyl-alpha-methylstyrenes wherein the alkyl groups differ from each other, ring-substituted alkyl- or polyalkylchlorostyrenes in which the alkyl group(s) contain(s) from one to four carbon atoms, and similar polymerizable styrenic monomers—i.e., styrenic compounds capable of being polymerized by means of peroxide or like catalysts into thermoplastic resins.

The polystyrene homopolymers or copolymers are preferrably formed using the styrenic monomers from the list consisting of styrene, p-methyl-styrene, 2,4-dimethylstyrene, alpha-methylstyrene, and p-chloro-styrene. These monomers are preferred from the standpoints of cost and availability.

Blowing Agent

Any of a wide variety of known foaming agents or blowing agents can be used in producing the expanded or foamed polymers of this invention. U.S. Pat. No. 3,960,792 gives a listing of some suitable materials. Generally speaking, volatile carbon-containing chemical substances are the most widely used for this purpose. They include, for example, such materials as aliphatic hydrocarbons including ethane, ethylene, propane, propylene, butane, butylene, isobutane, pentane, neopentane, isopentane, hexane, heptane and mixtures thereof; volatile halocarbons and/or halohydrocarbons, such as methyl chloride, chlorofluoromethane, bromochlorodifluoromethane, 1,1,1-trifluoroethane, 1,1,1,2-tetrafluoroethane, dichlorofluoromethane, dichlorodifluoromethane, chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane; and mixtures of such material. One preferred fluorine-containing blowing agent is 1,1-difluoroethane also known as HFC-152a (FORMACEL Z-2, E. I. dupont de Nemours and Co.) because of its reported desirable ecological properties. Water-containing vegetable matter such as finely-divided corn cob can also be used as blowing agents.

The weight percent of component of blowing agent added depends primarily on the degree of foaming desired; it depends also on the respective gas yield from the blowing agent employed. In general, 0.05 to 5 percent by weight, preferably 0.1 to 2 percent by weight of the composition of blowing agent is used based on the weight of the polystyrene.

Light Absorber of Component (b)

The light absorber of component (b) is selected from one or more of the group comprising

2-(2-hydroxyphenyl)-2H-benxotriazoles, 2-Hydroxybenzophenones, esters of substituted and unsubstituted benzoic acids, acrylates and malonates, oxamides, and tris-aryl-o-hydroxyphenyl-s-triazines.

Accordingly, examples of each class of light absorbers are listed below.

2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-a-cumyl-2-hydroxyphenyl)-2H-benzotriazole, 2-(3-t-butyl-2-hydroxy-5-(2-(co-hydroxy-octa-(ethyleneoxy)carbonyl-ethyl)-,phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-a-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-a-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzo-triazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butyl-phenyl)-2H-benzotriazole, 5-trifluoromethyl-2-(2-hydroxy-3,5-di-t-butylphenyl)-2H-benzo-triazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Esters of substituted and unsubstituted benzoic acids, as for example 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-d i-tert-butyl-4-hydroxybenzoate.

Acrylates and malonates, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, Sanduvor® PR25, dimethyl p-methoxybenzylidenemalonate (CAS# 7443-25-6), and Sanduvor® PR31, di-(1,2,2,6,6-pentamethylpiperidin-4-yl) p-methoxybenzylidenemalonate (CAS #147783-69-5).

Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Tris-aryl-o-hydroxyphenyl-s-triazines, for example known commercial tris-aryl-o-hydroxyphenyl-s-triazines and triazines as disclosed in, U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,187,919; 6,242,598 and 6,468,958, for example 4,6-bis-(2,4-dimethyl-phenyl)-2-(2-hydroxy-4-octyloxyphenyl)-s-triazine, Cyasorbe 1164, Cytec Corp, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)phenyl]-6-(4-bromophenyl)-s-triazine, 2,4-bis[2-hydroxy-4-(2-acetoxyethoxy)phenyl]-6-(4-chloro-phenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy4-(3-nonyloxy*-2-hydroxypropyloxy)-5-α-cumylphenyl]-s-triazine (* denotes a mixture of octyloxy, nonyloxy and decyloxy groups), methylenebis-{2,4-bis(2,4-dimethyl-phenyl)-6-[2-hydroxy-4-(3-butyloxy-2-hydroxypropoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxyphenyl)-s-triazine, 2,4-bis(2,4-dimethylphenyl)-6-(2-hydroxy4-hexyloxy-5-α-cumylphenyl)-s-triazine, 2-(2,4,6-trimethyl-phenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, Tinuvine 400, Ciba Specialty Chemicals Corp., 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

The weight percent of component (b) light absorber or mixtures thereof are advantageously contained in the composition of the invention in an amount for example from about 0.1 to about 10% by weight; preferably from about 0.5 to about 3% by weight based on the composition.

Preferably, component (b) comprises one or more compounds selected from (A) to (SS):
(A) 2-(3′,5′-di-tert-butyl-2′-hydroxyphenyl)-5-chlorobenzotriazole
(B) 2-(3′,5′-di-tert-amyl-2′-hydroxyphenyl)benzotriazole,
(C) 2-(3′,5′-bis(α,α,-dimethylbenzyl)-2′-hydroxyphenyl)benzotriazole,
(D) 2-(3′-tert-butyl-2′-hydroxy-5′-(2-octyloxycarbonylethyl)phenyl)benzotriazole,
(E) 2,2′-methylene-bis[4-(1,1,3,3-tetramethylbutyl)-6-benzotriazole-2-ylphenol],
(F) the transesterification product of 2-[3′-tert-butyl-5′-(2-methoxycarbonylethyl)-2′-hydroxyphenyl]-2H-benzotriazole with polyethylene glycol 300,
(G) 2-[2′-hydroxy-3′-(α,α-dimethylbenzyl)-5′-(1,1,3,3-tetramethylbutyl)phenyl]benzotriazole,
(H) 5-trifluoromethyl-2-(2-hydroxy-3-α-cumyl-5-tert-octylphenyl)-2H-benzo-triazole,
(I) 2-(2′-hydroxy-5′-(2-hydroxyethyl)phenyl)benzotriazole,
(J) 2-(2′-hydroxy-5′-(2-methacryloyloxyethyl)phenyl)benzotriazole,
(K) 2,4-bis(2,4-dimethylphenyl)-6-(2-hydroxy4-alkyloxyphenyl)-1,3,5-triazine, where alkyl is a mixture of C₈-alkyl groups (CAS Nos. 137759-38-7; 85099-51-0; 85099-50-9);
(L) 2,4-bis(2,4-dimethylphenyl)-6-(2-hydroxy4-octyloxyphenyl)-1,3,5-triazine (CAS No. 2725-22-6),
(M) 2,4-diphenyl-6-(2-hydroxy-4-[α-ethylhexanoyloxyethyl]phenyl)-1,3,5-triazine,
(N) 2,4-bis(2-hydroxy-4-butyloxyphenyl)-6-(2,4-bis-butyloxyphenyl)-1,3,5-triazine,
(O) 2,4,6-tris(2-hydroxy-4-[1-ethoxycarbonylethoxy]phenyl)-1,3,5-triazine,
(P) the reaction product of tris(2,4-dihydroxyphenyl)-1,3,5-triazine with the mixture of α-chloropropionic esters (made from isomer mixture of C₇-C₉alcohols),
(Q) 2-[4-(dodecyloxy/tridecyloxy-2-hydroxypropoxy)-2-hydroxyphenyl]-4,6-bis(2,4-dimethylphenyl)1,3,5-triazine,
(R) 2-{2-hydroxy-4-[3-(2-ethylhexyl-1-oxy)-2-hydroxypropyloxy]phenyl}-4,6-bis-(2,4-dimethylphenyl)-1,3,5-triazine,
(S) 2-(2-hydroxy4-hexyloxyphenyl)-4-6-diphenyl-1,3,5-triazine,
(T) 2-(3′-tert.butyl-5′-methyl-2′-hydroxyphenyl)-5-chloro-benzotriazole
(U) 2-(3′-sec. butyl-5′-tert.butyl-2′-hydroxyphenyl)-benzotriazole
(V) 2-(3′,5′-di-tert-butyl-2′-hydroxyphenyl)-benzotriazole
(W) 2-(5′-tert.octyl-2′-hydroxyphenyl)-benzotriazole
(X) 2-(3′-dodecyl-5′-methyl-2′-hydroxyphenyl)-benzotriazole
(Y) 2-(3′-tert.butyl-5′-(2-octyloxycarbonylethyl)-2′-hydroxyphenyl)-5-chloro-benzotriazole
(Z) 2-(5′-methyl-2′-hydroxyphenyl)-benzotriazole
(AA) 2-(5′-tert.butyl-2′-hydroxyphenyl)-benzotriazole
(BB) 2-(5′-[2-hydroxyethyl]-2′-hydroxyphenyl)-benzotriazole
(CC) 2-(5′-[2-methacryloyloxyethyl]-2′-hydroxyphenyl)-benzotriazole
(DD) the compound of formula 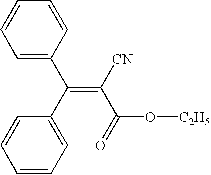
(EE) the compound of formula 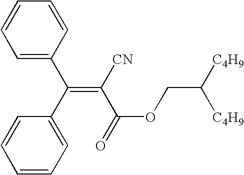
(FF) 2-ethylhexyl-p-methoxycinnamate (CAS No. 5466-77-3)
(GG) 2,4-dihydroxybenzophenone,
(HH) 2-hydroxy-4-methoxybenzophenone
(II) 2-hydroxy-4-dodecyloxybenzophenone
(JJ) 2-hydroxy-4-octyloxybenzophenone
(KK) 2,2′-dihydroxy-4-methoxybenzophenone
(LL) the compound of formula 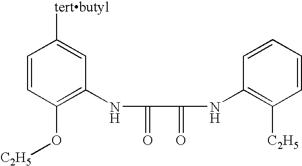
(MM) the compound of formula 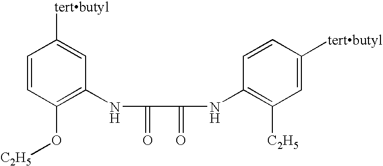
(NN) the compound of formula 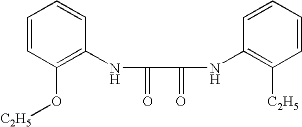
(OO) the compound of formula 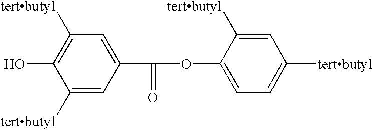
(PP) the compound of formula 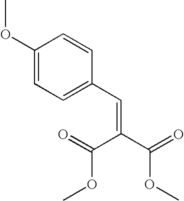
(QQ) the compound of formula 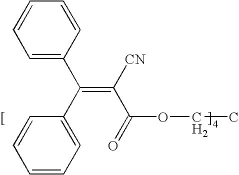
(RR) the compound of formula 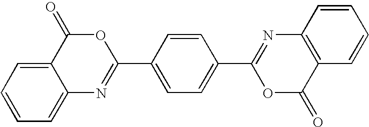
(SS) the compound of formula

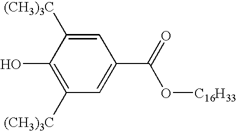

Most preferably the light absorber of component (b) comprises one or more compounds selected from the group comprising:

2-(2-hydroxyphenyl)-2H-benxotriazoles, 2-hydroxybenzophenones, and tris-aryl-o-hydroxyphenyl-s-triazines.

Components (c) and (d) Hindered Amine Stabilizers

The present sterically hindered amine stabilizers of components (c) and (d) are defined similarly; that is they have the same structural definitions and are distinguished by their molecular weight. The low molecular weight stabilizers of component (c) have a molecular weight of between about 200 to about 1000 g/mol. The high molecular weight stabilizers of component (d) have a molecular weight between about 1200 and about 10,000 g/mol.

The low molecular weight hindered amines are generally discrete monomeric compounds, or mixtures of such compounds. The high molecular weight hindered amines are generally oligomeric or polymeric compounds.

The present sterically hindered stabilizers of components (c) and (d) are well known in the art, and are for example of the formula 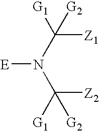
where
G₁ and G₂ are independently alkyl of 1 to 8 carbon atoms or are together pentamethylene,
Z₁ and Z₂ are each methyl, or Z₁ and Z₂ together form a linking moiety which may additionally be substituted by an ester, ether, amide, amino, carboxy or urethane group, and
E is hydrogen, oxyl, hydroxyl, alkyl with 1-8 carbon atoms, alkenyl with 1-8 carbon atoms, cycloalkyl, aryl, alkoxy of 1 to 18 carbon atoms, cycloalkoxy of 5 to 12 carbon atoms or aralkoxy of 7 to 15 carbon atoms, or —O—T—(OH)_{b} or substituted aryl.
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T.

Preferred structures for hindered amine stabilizers of both the low molecular weight and high molecular classes encompassed by components (c) and (d) include structures A thru R below

A pigmented polystyrene foam wherein the components (c) and (d) are of the formula A-R 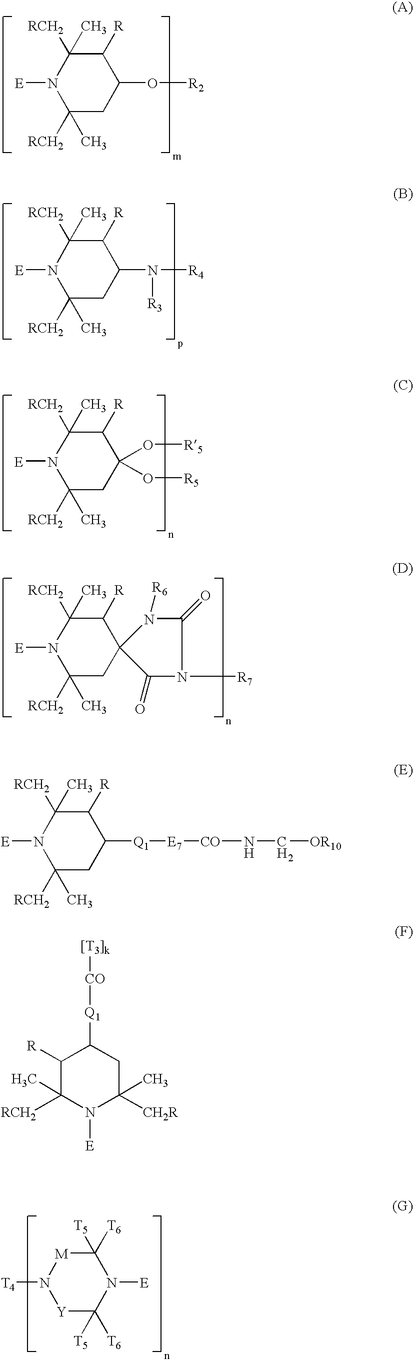 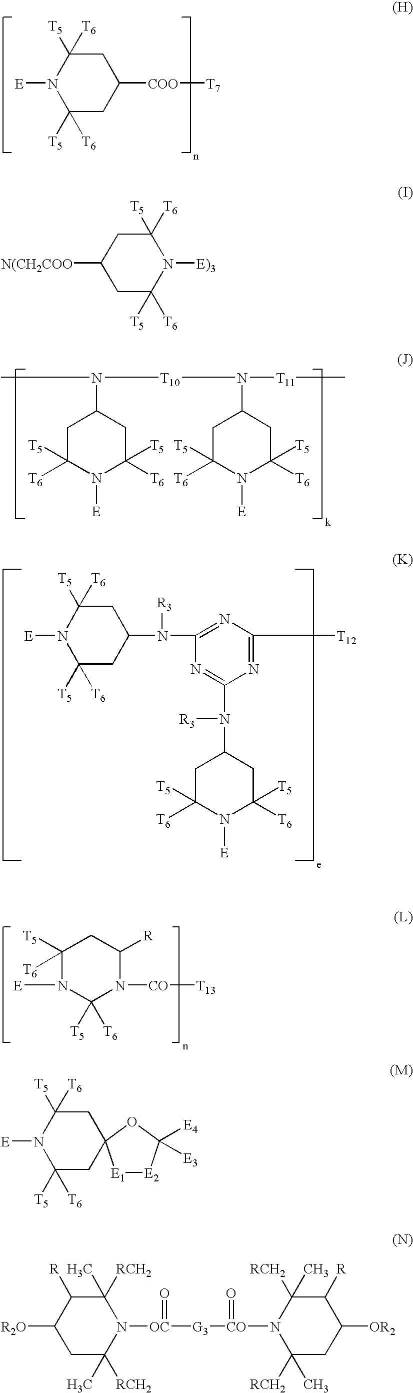 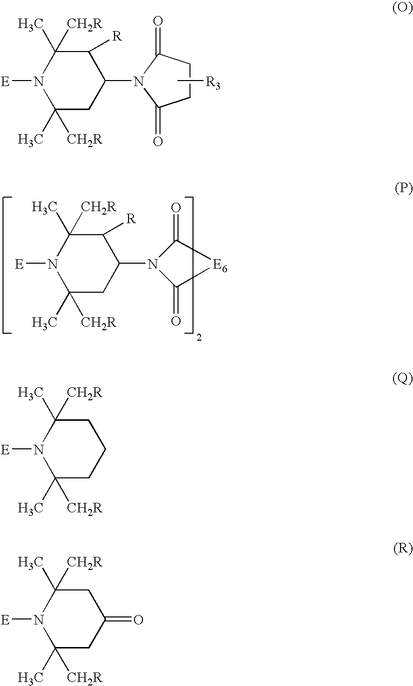
wherein
E is hydrogen, oxyl, hydroxy, alkyl with 1-8 carbon atoms, alkenyl with 1-8 carbon atoms, cycloalkyl, aryl, alkoxy of 1 to 18 carbon atoms, cycloalkoxy of 5 to 12 carbon atoms or aralkoxy of 7 to 15 carbon atoms, or —O—T—(OH)_{b} or substituted aryl.
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl,
m is 1 to 4,
when m is 1,
R₂ is hydrogen, C₁-C₁₈alkyl or said alkyl optionally interrupted by one or more oxygen atoms, C₂-C₁₂alkenyl, C₆-C₁₀aryl, C₇-C₁₈aralkyl, glycidyl, a monovalent acyl radical of an aliphatic,cycloaliphatic or aromatic carboxylic acid, or a carbamic acid, for example an acyl radical of an aliphatic carboxylic acid having 2-18 C atoms, of a cyclo-aliphatic carboxylic acid having 5-12 C atoms or of an aromatic carboxylic acid having 7-15 C atoms, or 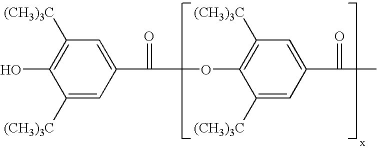
   wherein x is 0 or 1, 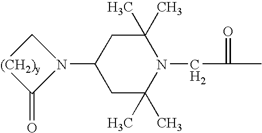
   wherein y is 2-4;
when m is 2,
R₂ is C₁-C₁₂alkylene, C₄-C₁₂alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 C atoms, of a cycloaliphatic or aromatic dicarboxylic acid having 8-14 C atoms, or of an aliphatic, cycloaliphatic or aromatic dicarbamic acid having 8-14 C atoms; 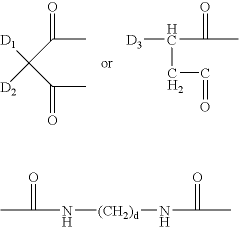
   wherein D₁ and D₂ are independently hydrogen, an alkyl radical containing up to 8 carbon atoms, an aryl or aralkyl radical including 3,5-di-t-butyl-4-hydroxybenzyl radical, D₃ is hydrogen, or an alkyl or alkenyl radical containing up to 18 carbon atoms, and d is 0-20;
when m is 3, R₂ is a trivalent acyl radical of an aliphatic, unsaturated aliphatic, cycloaliphatic, or aromatic tricarboxylic acid;
when m is 4, R₂ is a tetravalent acyl radical of a saturated or unsaturated aliphatic or aromatic tetracarboxylic acid including 1,2,3,4-butanetetracarboxylic acid, 1,2,3,4-but-2-enetetracarboxylic, and 1,2,3,5- and 1,2,4,5-pentanetetracarboxylic acid;
p is 1, 2 or 3,
R₃ is hydrogen, C₁-C₁₂alkyl, C₅-C₇cycloalkyl, C₇-C₉aralkyl, C₂-C₁₈alkanoyl, C₃-C₅alkenoyl or benzoyl;
when p is 1,
R₄ is hydrogen, C₁-C₁₈alkyl, C₅-C₇cycloalkyl, C₂-C₈alkenyl, unsubstituted or substituted by a cyano, carbonyl or carbamide group, aryl, aralkyl, or it is glycidyl, a group of the formula —CH₂—CH(OH)-Z or of the formula —CO-Z or —CONH-Z wherein Z is hydrogen, methyl or phenyl; or a group of the formulae

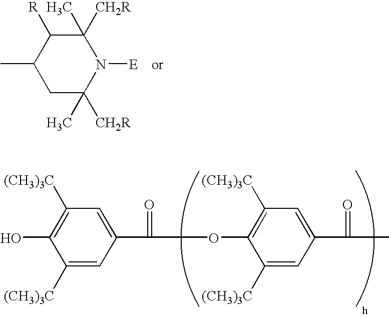

where h is 0 or 1,
R₃ and R₄ together, when p is 1, can be alkylene of 4 to 6 carbon atoms or 2-oxo-polyalkylene the cyclic acyl radical of an aliphatic or aromatic 1,2- or 1,3-dicarboxylic acid,
when p is 2,
R₄ is a direct bond or is C₁-C₁₂alkylene, C₆-C₁₂arylene, xylylene, a —CH₂CH(OH)—CH₂ group or a group —CH₂—CH(OH)—CH₂—O—X—O—CH₂—CH(OH)—CH₂— wherein X is C₂-C₁₀-alkylene, C₆-C₁₅arylene or C₆-C₁₂cycloalkylene; or, provided that R₃ is not alkanoyl, alkenoyl or benzoyl, R₄ can also be a divalent acyl radical of an aliphatic, cycloaliphatic or aromatic dicarboxylic acid or dicarbamic acid, or can be the group —CO—; or
R₄ is 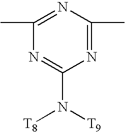
where T₈ and T₉ are independently hydrogen, alkyl of 1 to 18 carbon atoms, or T₈ and T₉ together are alkylene of 4 to 6 carbon atoms or 3-oxapentamethylene, for instance T₈ and T₉ together are 3-oxapentamethylene;
when p is 3,
R₄ is 2,4,6-triazinyl,
n is 1 or 2,
when n is 1,
R₅ and R′₅ are independently C₁-C₁₂ alkyl, C₂-C₁₂ alkenyl, C₇-C₁₂ aralkyl, or R₅ is also hydrogen, or R₅ and R′₅ together are C₂-C₈alkylene or hydroxyalkylene or C₄-C₂₂acyloxyalkylene;
when n is 2,
R₅ and R′₅ together are (—CH₂)₂C(CH₂—)₂;
R₆ is hydrogen, C₁-C₁₂alkyl, allyl, benzyl, glycidyl or C₂-C₆alkoxyalkyl;
when n is 1,
R₇ is hydrogen, C₁-C₁₂alkyl, C₃-C₅alkenyl, C₇-C₉aralkyl, C₅-C₇cycloalkyl, C₂-C₄hydroxyalkyl, C₂-C₆alkoxyalkyl, C₆-C₁₀aryl, glycidyl, a group of the formula —(CH₂)ₜ—COO-Q or of the formula —(CH₂)ₜ—O—CO-Q wherein t is 1 or 2, and Q is C₁-C₄alkyl or phenyl; or
when n is 2,
R₇ is C₂-C₁₂alkylene, C₆-C₁₂arylene, a group —CH₂CH(OH)—CH₂—O—X—O—CH₂—CH(OH)—CH₂— wherein X is C₂-C₁₀alkylene, C₆-C₁₅arylene or C₆-C₁₂cycloalkylene, or a group —CH₂CH(OZ′)CH₂—(OCH₂—CH(OZ′)CH₂)₂- wherein Z′ is hydrogen, C₁-C₁₈alkyl, allyl, benzyl, C₂-C₁₂alkanoyl or benzoyl;
Q₁ is —N(R₈)— or —O—; E₇ is C₁-C₃ alkylene, the group —CH₂—CH(R₉)—O— wherein R₉ is hydrogen, methyl or phenyl, the group —(CH₂)₃—NH— or a direct bond;
R₁₀ is hydrogen or C₁-C₁₈ alkyl, R₈ is hydrogen, C₁-C₁₈alkyl, C₅-C₇cycloalkyl, C₇-C₁₂aralkyl, cyanoethyl, C₆-C₁₀aryl, the group —CH₂—CH(R₉)—OH wherein R₉ has the meaning defined above; a group of the formula 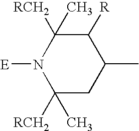
   or a group of the formula 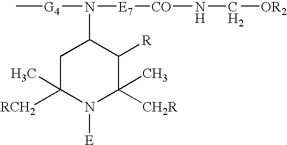
wherein G₄ is C₂-C₆alkylene or C₆-C₁₂arylene; or R₈ is a group -E₇-CO—NH—CH₂—OR₁₀;
Formula F denotes a recurring structural unit of a polymer where T₃ is ethylene or 1,2-propylene, is the repeating structural unit derived from an alpha-olefin copolymer with an alkyl acrylate or methacrylate; for example a copolymer of ethylene and ethyl acrylate, and where k is 2 to 100;
T₄ has the same meaning as R₄ when p is 1 or 2,
T₅ is methyl,
T₆ is methyl or ethyl, or T₅ and T₆ together are tetramethylene or pentamethylene, for instance T₅ and T₆ are each methyl,
M and Y are independently methylene or carbonyl, and T₄ is ethylene where n is 2;
T₇ is the same as R₇, and T₇ is for example octamethylene where n is 2,
T₁₀ and T₁₁ are independently alkylene of 2 to 12 carbon atoms, or T₁₁ is 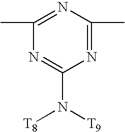
T₁₂ is piperazinyl,
—NR₁₁—(CH₂)_{d}—NR₁₁— or 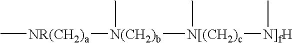
where R₁₁ is the same as R₃ or is also 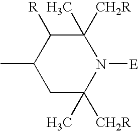
a, b and c are independently 2 or 3, and f is 0 or 1, for instance a and c are each 3, b is 2 and f is 1; and
e is 2, 3 or 4, for example 4;
T₁₃ is the same as R₂ with the proviso that T₁₃ cannot be hydrogen when n is 1;
E₁ and E₂, being different, each are —CO— or —N(E₅)- where E₅ is hydrogen, C₁-C₁₂ alkyl or C₄-C₂₂ alkoxycarbonylalkyl, for instance E₁ is —CO— and E₂ is —N(E₅)-,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 to 12 carbon atoms, or
E₃ and E₄ together are polymethylene of 4 to 17 carbon atoms, or said polymethylene substituted by up to four alkyl groups of 1 to 4 carbon atoms, for example methyl,
E₆ is an aliphatic or aromatic tetravalent radical,
R₂ of formula (N) is a previously defined when m is 1;
G₁ a direct bond, C₁-C₁₂ alkylene, phenylene or —NH-G′—NH wherein G′ is C₁-C₁₂ alkylene; or
wherein the hindered amine compound is a compound of the formula I, II, III, IV, V, VI, VII, VIII, IX, X or XI 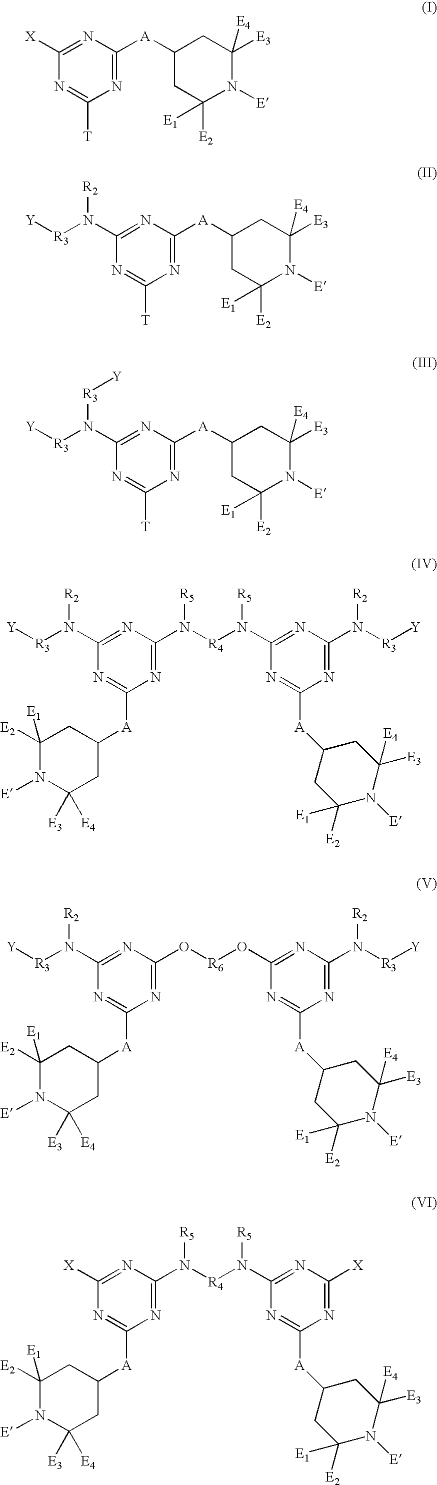 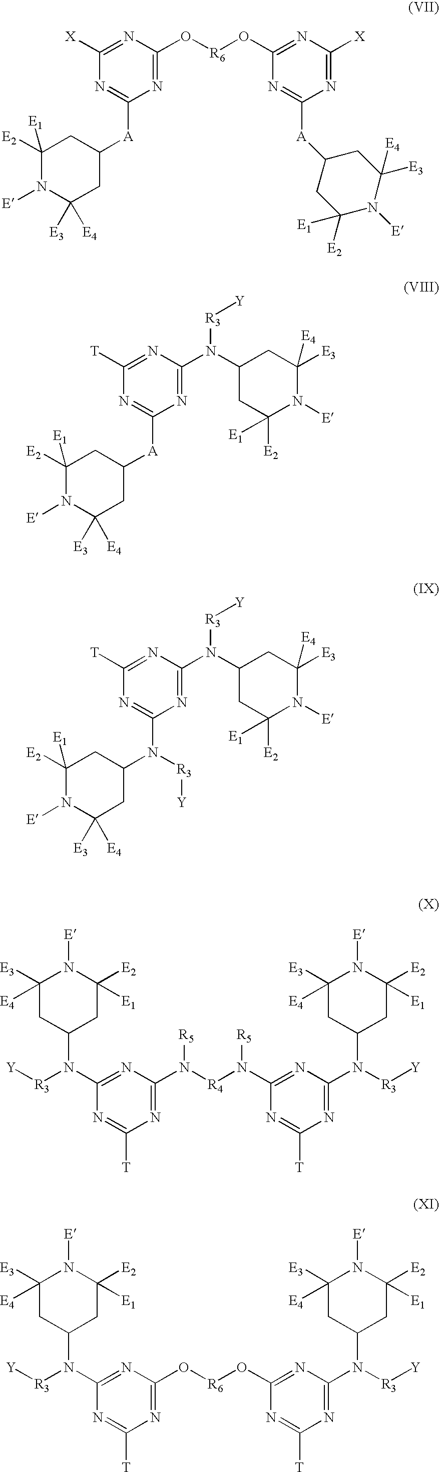
   wherein
E₁, E₂, E₃ and E₄ are independently alkyl of 1 to 4 carbon atoms, or E₁ and E₂ are independently alkyl of 1 to 4 carbon atoms and E₃ and E₄ taken together are pentamethylene, or E₁ and E₂; and E₃ and E₄ each taken together are pentamethylene,
E′ is hydrogen, oxyl, hydroxy, alkyl with 1-8 carbon atoms, alkenyl with 2-8 carbon atoms, cycloalkyl, aryl, alkoxy of 1-18 carbon atoms, cycloalkoxy of 5 to 12 carbon atoms or aralkoxy of 7 to 15 carbon atoms, or —O-T-(OH)_{b} or substituted aryl.

T and b is defined as above.
R₂ is hydrogen or a linear or branched chain alkyl of 1 to 12 carbon atoms,
R₃ is alkylene of 1 to 8 carbon atoms, or R₃ is —CO—, —CO—R₄—, —CONR₂—, or —CO—NR₂—R₄—,
R₄ is alkylene of 1 to 8 carbon atoms,
R₅ is hydrogen, a linear or branched chain alkyl of 1 to 12 carbon atoms, or 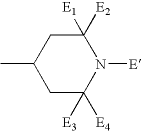
or when R₄ is ethylene, two R₅ methyl substituents can be linked by a direct bond so that the triazine bridging group —N(R₅)—R₄—N(R₅)— is a piperazin-1,4-diyl moiety,
R₆ is alkylene of 2 to 8 carbon atoms or R₆ is 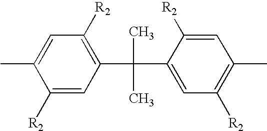
   with the proviso that Y is not —OH when R₆ is the structure depicted above,

A is —O— or —NR₇— where R₇ is hydrogen, a straight or branched chain alkyl of 1 to 12 carbon atoms, or R₇ is 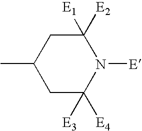
T is phenoxy, phenoxy substituted by one or two alkyl groups of 1 to 4 carbon atoms, alkoxy of 1 to 8 carbon atoms or —N(R₂)₂ with the stipulation that R₂ is not hydrogen, or T is 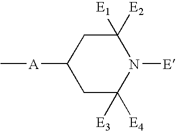
X is —NH₂, —NCO, —OH, —O-glycidyl, or —NHNH₂, and
Y is —OH, —NH₂, —NHR₂ where R₂ is not hydrogen; or Y is —NCO, —COOH, oxiranyl, —O-glycidyl, or —Si(OR₂)₃; or the combination R₃—Y— is —CH₂CH(OH)R₂ where R₂ is alkyl or said alkyl interrupted by one to four oxygen atoms, or R₃—Y— is —CH₂OR₂;
or
wherein the hindered amine compound is a mixture of N,N′,N′″-tris{2,4-bis[(1-hydrocarbyloxy-2,2,6,6-tetramethylpiperidin-4-yl)alkylamino]-s-triazin-6-yl}-3,3′-ethylene-diiminodipropylamine; N,N′,N″-tris{2,4-bis[(1-hydrocarbyloxy-2,2,6,6-tetramethylpiperidin-4-yl)alkylamino]-s-triazin-6-yl}-3,3′-ethylenediiminodipropylamine, and bridged derivatives as described by formulas I, II, IIA and III
   R₁NH—CH₂CH₂CH₂NR₂CH₂CH₂NR₃CH₂CH₂CH₂NHR₄ (I)
   T-E₁-T₁ (II)
   T-E₁ (IIA)
   G-E₁-G₁-E₁-G₂ (III)
   where in the tetraamine of formula I
R₁ and R₂ are the s-triazine moiety E; and one of R₃ and R4 is the s-triazine moiety E with the other of R₃ or R₄ being hydrogen,
   E is 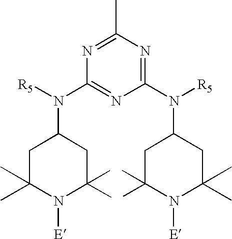
R is methyl, propyl, cyclohexyl or octyl,
R₅ is alkyl of 1 to 12 carbon atoms,
   where in the compound of formula II or IIA when R is propyl, cyclohexyl or octyl,
T and T₁ are each a tetraamine substituted by R₁-R₄ as is defined for formula I, where
(1) one of the s-triazine moieties E in each tetraamine is replaced by the group E₁ which forms a bridge between two tetraamines T and T₁,
   E₁ is 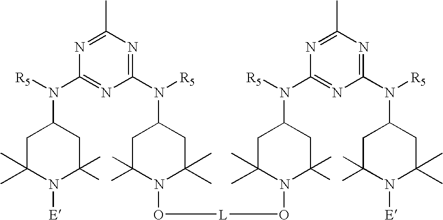
   or
(2) the group E₁ can have both termini in the same tetraamine T as in formula IIA where two of the E moieties of the tetraamine are replaced by one E₁ group, or
(3) all three s-triazine substituents of tetraamine T can be E₁ such that one E₁ links T and T₁ and a second E₁ has both termini in tetraamine T,
L is propanediyl, cyclohexanediyl or octanediyl;
   where in the compound of formula III
G, G₁ and G₂ are each tetraamines substituted by R₁-R₄ as defined for formula I, except that G and G₂ each have one of the s-triazine moieties E replaced by E₁ and G₁ has two of the triazine moieties E replaced by E₁, so that there is a bridge between G and G₁ and a second bridge between G₁ and G₂;
which mixture is prepared by reacting two to four equivalents of 2,4-bis[(1-hydro-carbyloxy-2,2,6,6-piperidin-4-yl)butylamino]-6-chloro-s-triazine with one equivalent of N,N′-bis(3-aminopropyl)ethylenediamine;
   or the hindered amine is a compound of the formula IIIb 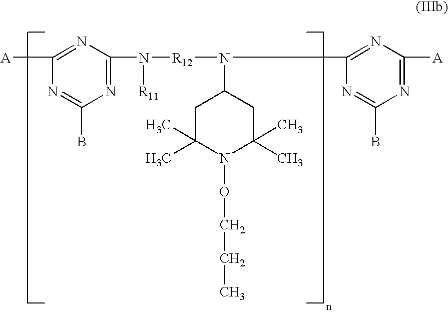
in which the index n ranges from 1 to 15;
R₁₂ is C₂-C₁₂alkylene, C₄-C₁₂alkenylene, C₅-C₇cycloalkylene, C₅-C₇cycloalkylene-di(C₁-C₄alkylene), C₁-C₄alkylenedi(C₅-C₇cycloalkylene), phenylenedi(C₁-C₄alkylene) or C₄-C₁₂alkylene interrupted by 1,4-piperazinediyl, —O— or >N—X₁ with X, being C₁-C₁₂acyl or (C₁-C₁₂alkoxy)carbonyl or having one of the definitions of R₁₄ given below except hydrogen; or R₁₂ is a group of the formula (Ib′) or (Ic′); 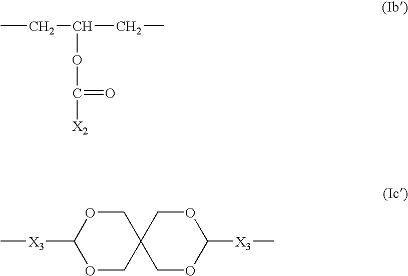
with m being 2 or 3,
X₂ being C₁-C₁₈alkyl, C₅-C₁₂cycloalkyl which is unsubstituted or substituted by 1, 2 or 3
   C₁-C₄alkyl; phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; and
the radicals X₃ being independently of one another C₂-C₁₂alkylene;
R₁₃, R₁₄ and R₁₅, which are identical or different, are hydrogen, C₁-C₁₈alkyl, C₅-C₁₂cycloalkyl which is unsubstituted or substituted by 1, 2 or 3 C₁-C₄alkyl; C₃-C₁₈alkenyl, phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; tetrahydrofurfuryl or
   C₂-C₄alkyl which is substituted in the 2, 3 or 4 position by —OH, C₁-C₈alkoxy, di(C₁-C₄alkyl)amino or a group of the formula (Ie′); 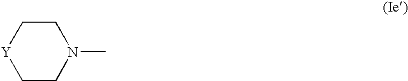
with Y being —O—, —CH₂—, —CH₂CH₂— or >N—CH₃,
or —N(R₁₄)(R₁₅) is additionally a group of the formula (Ie′);
the radicals A are independently of one another —OR₁₃, —N(R₁₄)(R₁₅) or a group of the formula (IIId); 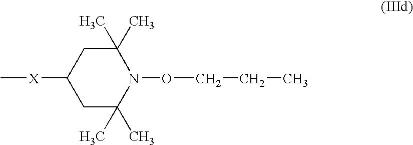
X is —O— or >N—R₁₆;
R₁₆ is hydrogen, C₁-C₁₈alkyl, C₃-C₁₈alkenyl, C₅-C₁₂cycloalkyl which is unsubstituted or substituted by 1, 2 or 3 C₁-C₄alkyl; C₇-C₉phenylalkyl which is unsubstituted or substituted on the phenyl by 1, 2 or 3 C₁-C₄alkyl; tetrahydrofurfuryl, a group of the formula (IIIf), 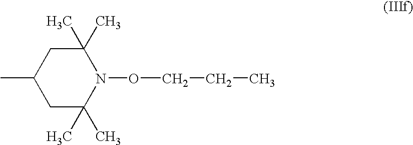
   or C₂-C₄alkyl which is substituted in the 2, 3 or 4 position by —OH, C₁-C₈alkoxy, di(C₁-C₄alkyl)amino or a group of the formula (Ie′);
R₁₁ has one of the definitions given for R₁₆; and
the radicals B have independently of one another one of the definitions given for A.

Alkyl is straight or branched and is for example methyl, ethyl, n-propyl, n-butyl, sec-butyl, tert-butyl, n-hexyl, n-octyl, 2-ethylhexyl, n-nonyl, n-decyl, n-undecyl, n-dodecyl, n-tridecyl, n-tetradecyl, n-hexadecyl or n-octadecyl.

Cycloalkyl groups include cyclopentyl and cyclohexyl; typical cycloalkenyl groups include cyclohexenyl; while typical aralkyl groups include benzyl, alpha-methyl-benzyl, alpha,alpha-dimethylbenzyl or phenethyl.

If R₂ is a monovalent acyl radical of a carboxylic acid, it is for example an acyl radical of acetic acid, stearic acid, salicyclic acid, benzoic acid or □-(3,5-di-tert-butyl-4-hydroxyphenyl) propionic acid.

If R₂ is a divalent acyl radical of a dicarboxylic acid, it is for example an acyl radical of oxalic acid, adipic acid, succinic acid, suberic acid, sebacic acid, phthalic acid dibutylmalonic acid, dibenzylmalonic acid or butyl-(3,5-di-tert-butyl-4-hydropxybenzyl)-malonic acid, or bicycloheptenedicarboxylic acid, with succinates, sebacates, phthalates and isophthalates being specific examples.

If R₂ is a divalent acyl radical of a dicarbamic acid, it is for example an acyl radical of hexamethylenedicarbamic acid or of 2,4-toluylenedicarbamic acid.

The hindered alkoxyamine stabilizers of components (i) and (ii) are well known in the art, also known as N-alkoxy hindered amines and NOR hindered amines or NOR hindered amine light stabilizers or NOR HALS.

They are disclosed for example in U.S. Pat. Nos. 5,004,770, 5,204,473, 5,096,950, 5,300,544, 5,112,890, 5,124,378, 5,145,893, 5,216,156, 5,844,026, 6,117,995, 6,271,377, and U.S. application Ser. No. 09/505,529, filed Feb. 17, 2000, Ser. No. 09/794,710, filed Feb. 27, 2001, Ser. No. 09/714,717, filed Nov. 16, 2000, Ser. No. 09/502,239, filed Nov. 3, 1999 and Ser. No. 60/312,517, filed Aug. 15, 2001. The relevant disclosures of these patents and applications are hereby incorporated by reference.

U.S. Pat. No. 6,271,377, and U.S. application Ser. Nos. 09/505,529, filed Feb. 17, 2000, and Ser. No. 09/794,710, filed Feb. 27, 2001, cited above disclose hindered hydroxyalkoxyamine stabilizers. For the purposes of this invention, the hindered hydoxyalkoxyamine stabilizers are considered a subset of the hindered alkoxyamine stabilizers and are part of present components (i) and (ii). Hindered hydroxyalkoxyamine stabilizers are also known as N-hydroxyalkoxy hindered amines, or NORol HALS.

Preferred low molecular weight hindered amine light stabilizers or mixtures thereof are selected from at least one from the group consisting of

4-hydroxy-2,2,6,6-tetramethylpiperidine, 1-allyl4-hydroxy-2,2,6,6-tetramethylpiperidine, 1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, tris(2,2,6,6-tetramethyl-4-piperidyl) nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl) malonate, 3-n-octyl-7,7,9,9-tetramethyl-1,3,8-triazaspiro[4.5]decan-2,4-dione, bis(l -octyloxy-2,2,6,6-tetramethylpiperidyl) sebacate, bis(1-octyloxy-2,2,6,6-tetramethylpiperidyl) succinate, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine.

The most preferred list of low molecular weight hindered amine light stabilizers of component (c) wherein at least one is selected from the group consisting of

4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, tetrakis(2,2,6,6-tetramethyl4-piperidyl)-1,2,3,4-butane-tetracarboxylate 4-benzoyl-2,2,6,6-tetramethylpiperidine, 4-stearyloxy-2,2,6,6-tetramethylpiperidine, bis(1-octyloxy-2,2,6,6-tetramethylpiperidyl) sebacate, bis(1-octyloxy-2,2,6,6-tetramethyl-piperidyl) succinate, a mixture of 4-hexadecyloxy- and 4-stearyloxy-2,2,6,6-tetramethylpiperidine, N-(2,2,6,6-tetramethyl-4-piperidyl)-n-dodecylsuccinimide, N-(1,2,2,6,6-pentamethyl-4-piperidyl)-n-dodecylsuccinimide, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine.

The most preferred high molecular weight hindered amine light stabilizers of component (d) is selected from at least one compound from the group consisting of
linear or cyclic condensates of N,N′-bis(2,2,6,6-tetramethyl-4-piperidyl)hexamethylenediamine and 4-tert-octylamino-2,6-dichloro-1,3,5-triazine [CHIMASSORB 944]
linear or cyclic condensates of N,N′-bis-(2,2,6,6-tetramethyl-4-piperidyl)-hexamethylenediamine and 4-morpholino-2,6-dichloro-1,3,5-triazine [CYASORB UV-3346]
a condensation product of N,N′-bis(2,2,6,6-tetramethyl-4-piperidyl)hexamethylenediamine and 4-cyclohexylamino-2,6-dichloro-1,3,5-triazine
1,6-Hexanediamine, N,N′-bis(2,2,6,6-tetramethyl-4-piperidinyl)-, polymers with morpholine-2,4,6-trichloro-1,3,5-triazine reaction products, methylated [CYASORB UV 3529]
1,6-Hexanediamine, N,N′-bis(2,2,6,6-tetramethyl-4-piperidinyl)-, polymer with 2,4,6-trichloro-1,3,5-triazine, reaction products with,N-butyl-1-butanamine and N-butyl-2,2,6,6-tetramethyl-4-piperidinamine [CHIMASSORB 2020]
1,3-Propanediamine, N,N″-1,2-ethanediylbis-, polymer with 2,4,6-trichloro-1,3,5-triazine, reaction products with N-butyl-2,2,6,6-tetramethyl4-piperidinamine [UVASORB HA 88]
2,4,8,10-Tetraoxaspiro[5.5]undecane-3,9-diethanol, β,β,β′,β′-tetramethyl-, polymer with 1,2,3,4-butanetetracarboxylic acid, 1,2,2,6,6-pentamethyl-4-piperidinyl ester [ADK STAB LA 63]
1,3,5-Triazine-2,4,6-triamine, N,N′″-1,2-ethanediylbis[N-[3-[[4,6-bis[butyl(1,2,2,6,6-pentamethyl-4-piperidinyl)amino]-1,3,5-triazin-2-yl]amino]propyl]-N′,N″-dibutyl-N′,N″-bis(1,2,2,6,6-pentamethyl-4-piperidinyl)-[CHIMASSORB 119]
1,2,3,4-Butanetetracarboxylic acid-β,β,β′, β′-tetramethyl-2,4,8,10-tetraoxaspiro[5.5]undecane-3,9-diethanol copolymer,2,2,6,6-tetramethyl-4-piperidinyl ester [ADK STAB LA 68]
1,6-Hexanediamine, N ,N′-bis(2,2,6,6-tetramethyl-4-piperidinyl)-, polymer with 2,4-dichloro-6-(4-morpholinyl)-1,3,5-triazine [CYASORB UV-3346]

Components (c)+(d) in total, are advantageously contained in the composition of the invention in an amount from for example from about 0.2 to about 8% based on the polymer substrate (a), preferably for instance from about 0.2 to about 3% by weight.

Components (c) and (d) are employed in a weight ratio of (c): (d) of from about 3:1 to about 1:3, or from about 2:1 to about 1:2.

The ratio of the weight of component (b) light absorber or mixtures of light absorberes to total weight of components (c)+(d) thereof are for instance from about 3:1 to about 1:3, or from about 2:1 to about 1:2.

Component (e) Pigment

The pigments used in the instant compositions can be any pigment or mixtures of pigments selected from the group consisting of

Pigment Black 7, Pigment Black 11, Pigment Black 12, Pigment Black 26, Pigment Black 27, Pigment Black 28, Pigment Black 30, Pigment Blue 7, Pigment Blue 15.1, Pigment Blue 15.3, Pigment 15:4, Pigment 15:2, Pigment Blue 28, Pigment Blue 29, Pigment Blue 36, Pigment Blue 60, Pigment Brown 11, Pigment Brown 23, Pigment Brown 24, Pigment Brown 33, Pigment Brown 35, Pigment Green 17, Pigment Green 26, Pigment Green 36, Pigment Green 50, Pigment Green 7, Pigment Red 104, Pigment Red 110, Pigment Red 122, Pigment Red 101, Pigment Red 178, Pigment Red 202, Pigment Red 254, Pigment Red 149, Pigment Red 108, Pigment Violet 14, Pigment Violet 15, Pigment Violet 16, Pigment Violet 19, Pigment Violet 23, Pigment Violet 29, Pigment Violet 37, Pigment Violet 47, Pigment Yellow 37, Pigment Violet 48, Pigment Yellow 53, Pigment Yellow 110, Pigment Yellow 119, Pigment Yellow 161, Pigment Yellow 162, Pigment Yellow 163, Pigment Yellow 164, Pigment Yellow 184, Pigment Yellow 199, Pigment Yellow 215, Pigment Yellow 34, Pigment Yellow 35, Chromothal Yellow 382 EOB (available from Ciba Specialty Chemical Corp.), Pigment Orange 61, Pigment Orange 20, Pigment White 21, Pigment White 22, Pigment White 4, Pigment White 5, Pigment White 7, and Pigment White 6.

Preferably the pigment or mixtures of the instant invention are selected from the group consisting of

Pigment White 6, Pigment Black 7, Pigment Red 101, Pigment Yellow 184, Pigment Brown 24, Pigment Blue 15:1, Pigment Blue 15:3, Pigment Blue 7, Pigment Yellow 215, Pigment Yellow 110, Chromothal Yellow 382 EOB (available from Ciba Specialty Chemical Corp.), Pigment Red 202, Pigment Violet 19, Pigment Red 149, Pigment Red 122, Pigment Yellow 119 and Pigment Black 27.

The total weight of pigment used in the final product will depend on the pigment mixture used and the desired final color. Preferably the weight % based on the total composition will vary from about .01% to about 4%. Most preferably the weight % based on the total composition will vary from about 0.05% to about 3%.

Preferably the composition contains at least one pigment which is not carbon black or titanium dioxide.

The total ratio of the weight of components (c)+(d) to total weight of component (e) is from about 3:1 to about 1:3.

Component (f) Carbon Black

The component (f) carbon black can be optionally added. Preferably the carbon black is advantageously contained in the composition of the invention in an amount from about 0.001 to about 0.2% wt. % based on the total composition. Most preferably, the carbon black is contained in the composition of the invention in an amount from about 0.001 to about 0.08 wt. % based on the composition.

The compositions of the instant invention are used in outdoor applications including fencing, decks, outdoor furniture, artificial stones, planters, containers, boxes, bins for storage, window trim, decorative siding, window boxes, mailboxes and transportation.

The foamed polystyrene materials containing the stabilizers described herein can be used for the production of moldings, rotomolded articles, injection molded articles, blow molded articles, mono- and multiplayer films, extruded profiles, surface coatings and the like.

The resulting stabilized pigmented polystyrene compositions of the invention may optionally also contain from about 0.01 to about 5%, conventional additives, such as the materials listed below, or mixtures thereof.

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl4-methoxymethylphenol, nonylphenols which are linear or branched in the side chains, for example, 2,6-di-nonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl4-hydroxyphenyl stearate, bis-(3,5-di-tert-butyl4-hydroxyphenyl) adipate.

1.4. Tocopherols, for example α-tocopherol, β-tocopherol, γ-tocopherol, 6-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl4-hydroxy-5-methyl-phenyl)dicyclopentadiene, bis[2-(3′tert-butyl-2-hydroxy-5-methylbenzyl)-6-tert-butyl4-methylphenyl]terephthalate, 1,1-bis-(3,5-dimethyl-2-hydroxyphenyl)butane, 2,2-bis-(3,5-di-tert-butyl4-hydroxyphenyl)propane, 2,2-bis-(5-tert-butyl4-hydroxy2-methylphenyl)-4-n-dodecylmercaptobutane, 1,1,5,5-tetra-(5-tert-butyl-4-hydroxy-2-methylphenyl)pentane.

1.7. Benzyl compounds, for example 3,5,3′,5′-tetra-tert-butyl4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, 1,3,5-tri-(3,5-di-tert-butyl-4-hydroxybenzyl)-2,4,6-trimethylbenzene, di-(3,5-di-tert-butyl-4-hydroxybenzyl) sulfide, 3,5-di-tert-butyl-4-hydroxybenzyl-mercapto-acetic acid isooctyl ester, bis-(4-tert-butyl-3-hydroxy-2,6-dimethylbenzyl)dithiol terephthalate, 1,3,5-tris-(3,5-di-tert-butyl-4-hydroxybenzyl) isocyanurate, 1,3,5-tris-(4-tert-butyl-3-hydroxy-2,6-dimethylbenzyl) isocyanurate, 3,5-di-tert-butyl-4-hydroxybenzyl-phosphoric acid dioctadecyl ester and 3,5-di-tert-butyl-4-hydroxybenzyl-phosphoric acid monoethyl ester, calcium-salt.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl4-hydroxybenzyl)isocyanurate.

1.11. Benzylphosphonates, for example dimethyl-2,5-di-tert-butyl-4-hydroxybenzylphosphonate, diethyl-3,5-di-tert-butyl4-hydroxybenzylphosphonate, dioctadecyl3,5-di-tert-butyl4-hydroxybenzylphosphonate, dioctadecyl-5-tert-butyl4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxy-lauric acid anilide, 4-hydroxy-stearic acid anilide, 2,4-bis-octylmercapto-6-(3,5-tert-butyl-4-hydroxyanilino)-s-triazine and octyl-N-(3,5-di-tert-butyl-4-hydroxyphenyl)-carbamate.

1.13. Esters of β-(3.5-di-tert-butyl-4-hydroxyphenyl)Propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamine, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3.5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3.5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N, N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example β,β′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazin, N,N,N′,N′-tetraphenyl-1,4-diaminobut-2-ene, N,N-bis(2,2,6,6-tetramethyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

Light Stabilizers

2.1. Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

3. Metal deactivators, for example N,N′-diphenyloxamide, N-salicylal-N′-salicyloyl hydrazine, N,N′-bis(salicyloyl) hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-dibenzo(d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl) methyl phosphite, bis(2,4-di-tert-butyl-6-methylphenyl) ethyl phosphite, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite.

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N-methyl-N-octadecylhydroxylamine and the N,N-dialkylhydroxylamine derived from hydrogenated tallow amine.

6. Nitrones, for example N-benzyl-α-phenylnitrone, N-ethyl-α-methyinitrone, N-octyl-α-heptylnitrone, N-lauryl-α-undecylnitrone, N-tetradecyl-α-tridcylnitrone, N-hexadecyl-α-pentadecylnitrone, N-octadecyl-α-heptadecylnitrone, N-hexadecyl-α-heptadecylnitrone, N-ocatadecyl-α-pentadecylnitrone, N-heptadecyl-α-heptadecyinitrone, N-octadecyl-α-hexadecylnitrone, N-methyl-α-heptadecyInitrone and the nitrone derived from N,N-dialkylhydroxylamine derived from hydrogenated tallow amine.

7. Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide.

8. Benzofuranones and indolinones, for example 3-[4-(2-acetoxyethoxy)phenyl]-5,7-di-tert-butyl-benzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl4-pivaloyloxyphenyl)-5,7-di-tert-butyl-benzofuran-2-one, 3-(3,4-dimethylphenyl)-5,7-di-tert-butyl-benzofuran-2-one, Irganox® HP-136, Ciba Specialty Chemicals Corp., and 3-(2,3-dimethylphenyl)-5,7-di-tert-butyl-benzofuran-2-one.

9. Thiosynergists, for example dilauryl thiodipropionate or distearyl thiodipropionate.

10. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(□-dodecylmercapto)propionate.

11. Polyamide stabilizers, for example copper salts in combination with iodides and/or phosphorus compounds and salts of divalent manganese.

12. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, calcium stearate, zinc stearate, magnesium behenate, magnesium stearate, sodium ricinoleate and potassium palmitate, antimony pyrocatecholate or zinc pyrocatecholate.

13. Nucleating agents, for example inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

14. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

15. Dispersing Agents, such as polyethylene oxide waxes or mineral oil.

16. Other additives, for example plasticizers, lubricants, emulsifiers, pigments, dyes, optical brighteners, rheology additives, catalysts, flow-control agents, slip agents, crosslinking agents, crosslinking boosters, halogen scavengers, smoke inhibitors, flameproofing agents, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS# 18600-59-4), and blowing agents.

The foams of the present invention may be prepared by extrusion processes well known to one of ordinary skill in the art.

Styrenic foam materials, for example, rods or rectangular boards, are formed, as is known, by mixing the additives, either individually or as a masterbatch, with the polymer and then feeding the mixture to an extruder along with a foaming agent and, optionally, a nucleating agent, such as talc or commercially available carbonate-based materials, for example, the material sold under the trademark, Safoam-FP.

### EXAMPLES

A convenient way to add the stabilizers and pigments to the styrenic polymer is as a masterbatch, which is a concentrated, heat blended or extruded mixture of the various additives in the polymer. The concentration of additives usually ranges from about 10 to 90 percent by weight of the total weight of masterbatch composition, with the balance being polymer. The masterbatch is then added to the bulk of the styrenic polymer material, which may already contain other additives such as a zinc stearate lubricant. The masterbatch is added in proportions to give the desired concentration of additives in the final blended product.

### Example 1

A pigment concentrate or masterbatch was made by dry blending the materials listed in Table 1 and compounding and dispersing them through a Werner and Pfleiderer ZSK-30 co-rotating twin screw extruder with five temperature zones to form a molten strand. The temperature zones on the extruder were 150, 160, 170, 175, and 180° C. respectively. The molten strand was cooled and solidified in a water bath and then cut using an automatic, rotating blade to form pellets. These pellets constitute the pigment concentrate masterbatch. All weights are weight % of the composition.

TABLE I
Masterbatch Formulation for 24:1 Let Down Ration (LDR)¹

| | Color Index | |
|---|---|---|
| Pigments/Additives | Number | ⁶Wt. % |
| Iron Oxide² | Pigment Red | 1.10 |
| | 101 | |
| Carbon Black | Carbon | 0.06 |
| | Black | |
| Bismuth Vanadate³ | Pigment | 7.65 |
| | Yellow 184 | |
| Tinuvin P⁴ | Light | 12.5 |
| | absorber | |
| Hindered amine blend⁵ | Stabilizer | 12.5 |
| | Blend | |
| Polystyrene | | 66.2 |

¹Let Down Ratio refers to the ratio of materbatch concentrate to the amount of foamed polystyrene in the final product.
²Bayferrox ® Iron Oxide 110M - available from Bayer Corporation.
³Irgacolor ® Yellow 2GTM - Bismuth Vanadate encapsulated grade for heat and chemical resistance available from Ciba Specialty Chemical Corp., Tarrytown, NY
⁴Tinuvin P - 2-(2-hydroxy-5-methylphenyl)-2H-benzotriazole available from Ciba Specialty Chemical Corp., Tarrytown, NY
⁵1:1 blend of bis(2,2,6,6-tetramethyl-4-piperidyl) sebacate (2440-22-4)
and linear or cyclic condensates of N,N′-bis(2,2,6,6-tetramethyl-4-piperidyl)hexamethylenediamine and 4-tert-octylamino-2,6-dichloro-1,3,5-triazine (71878-19-8 and 70624-18-9).
⁶Weight % based on Masterbatch composition.

Incorporation of Masterbatch into Final Product (Let Down)

The pelletized materbatch is then added to additional polystyrene and blown into foam to make the final composition in Table II.

### Example 2

A segmented single screw extruder with a rod die was used for foaming the mixture of the masterbatch prepared in Example 1. The screw was designed to operate in three stages: a plasticization section, a gas injection section, and a metering and mixing section. A small amount (0.05 wt % of composition) of nucleating agent was also dry blended with the mixture. The mixture was metered through a single screw feeder. C0₂ gas was used as a physical blowing agent for foaming the polystyrene blends. The resulting concentration of additives and pigments in the final product is shown in TABLE II. The weight % is based on the weight of the composition.

TABLE II

| Component Concentration | | |
|---|---|---|
| in Final Product | | |
| Pigments/Additive | Color Index Number | ¹Wt. % |
| Iron Oxide | Pigment Red 101 | 0.05 |
| Carbon Black | Carbon Black | 0.002 |
| Bismuth Vanadate | Pigment Yellow 184 | 0.31 |
| Tinuvin P | Light absorber | 0.50 |
| Hindered amine blend | Stabilizer Blend | 0.50 |

¹Weight % based on the final polymer composition.

Application Results

Test samples are tested according to ASTM G 26. Test samples are mounted in metal frames and exposed in an ®Atlas Ci65 Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray).

Initial color measurements using ASTM D 2244 are taken using the above parameters. The L, a and b values are calculated using the CIE system from the reflectance values. Subsequent measurements are taken at specified intervals. ΔL, Δa, and Δb values are simply the difference between the initial values and the values at each interval. ΔE is calculated as follows:
[(ΔL)²+(Δa)²+(Δb)²]^{1/2}=ΔE
Control

Test samples of foamed polystyrene are molded as in example 2 but without the masterbatch of additives and pigments in Table II. A pigmented coating was applied to the foamed polystryene directly after extrusion and ΔE readings were taken at the same time intervals as example 2 foamed polystyrene.

The pigmented stabilized molded samples of example 2 show good resistance to color change upon UV exposure. The pigmented coating applied to the unstabilized foamed polystyrene samples show delamination and very large ΔE after 3000 hours.

Δ E Color Change

| | 500 | 1000 | 2000 | 3000 |
|---|---|---|---|---|
| Exposure Time | Hours | Hours | Hours | Hours |
| Control - painted polystyrene | 3.7 | 7.8 | 9.0 | 6.7 |
| UV stabilized plaques containing | 1.7 | 1.2 | 1.0 | 0.7 |
| composition of example 2 | | | | |

1. A pigmented polystyrene foam composition comprising
a) a foam polystyrene homopolymer or copolymer,
b) at least one light absorber,
c) at least one compound selected from the group consisting of low molecular weight hindered amine light stabilizer,
d) at least one compound selected from the group consisting of high molecular weight hindered amine light stabilizer,
e) at least one pigment or pigment mixture and
f) optionally, carbon black,
wherein the expanded polymer foam shows a Δ E color change when exposed under a Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0, wherein Δ E color change is determined according to ASTM method D2244.

2. A pigmented polystyrene foam composition according to claim 1 wherein component (a) foam polystyrene homopolymers or copolymers are formed using styrenic monomers selected from the group consisting of styrene, p-methyl-styrene, 2,4-dimethylstyrene, alpha-methylstyrene, and p-chloro-styrene.

3. A pigmented polystyrene foam composition according to claim 1 wherein at least one component (b) is selected from group consisting of
2-(2-hydroxyphenyl)-2H-benzotriazoles, 2-hydroxybenzophenones, esters of substituted and unsubstituted benzoic acids, acrylates and malonates, oxamides, and tris-aryl-o-hydroxyphenyl-s-triazines.

4. A pigmented polystyrene foam composition according to claim 3 wherein at least one component (b) is selected from the group consisting of 2-(2-hydroxyphenyl)-2H-benzotriazoles, 2-hydroxybenzophenones and tris-aryl-o-hydroxyphenyl-s-triazines.

5. A pigmented polystyrene foam composition according to claim 3 wherein the total weight percent of the component (b) light absorber or mixtures thereof are advantageously contained in the composition of the invention in an amount from about 0.5 to about 3% by weight based on the total foam composition.

6. A pigmented polystyrene foam composition according to claim 1 wherein component (c) hindered amine light stabilizer has a molecular weight of about 200 to about 1,000 g/mol and component (d) hindered amine light stabilizer has a molecular weight of about 1,200 to about 10,000 g/mol.

7. A pigmented polystyrene foam composition according to claim 1 wherein components (c) and (d) are of the formula 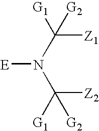
where
G₁ and G₂ are independently alkyl of 1 to 8 carbon atoms or are together pentamethylene,
Z₁ and Z₂ are each methyl, or Z₁ and Z₂ together form a linking moiety which may additionally be substituted by an ester, ether, amide, amino, carboxy or urethane group, and
E is hydrogen, oxyl, hydroxy, alkyl with 1-8 carbon atoms, alkenyl with 2-8 carbon atoms, cycloalkyl, aryl, alkoxy, cycloalkoxy, aralkoxy, aryloxy, —O—CO—OZ₃, —O—Si(Z₄)₃, —O—PO(OZ₅)₂ or —O—CH₂—OZ₆ where Z₃, Z₄, Z₅ and Z₆ are selected from the group consisting of hydrogen, an aliphatic, araliphatic and aromatic moiety; or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T.

8. A pigmented polystyrene foam according to claim 6 wherein the components (c) and (d) are of the formula A-R 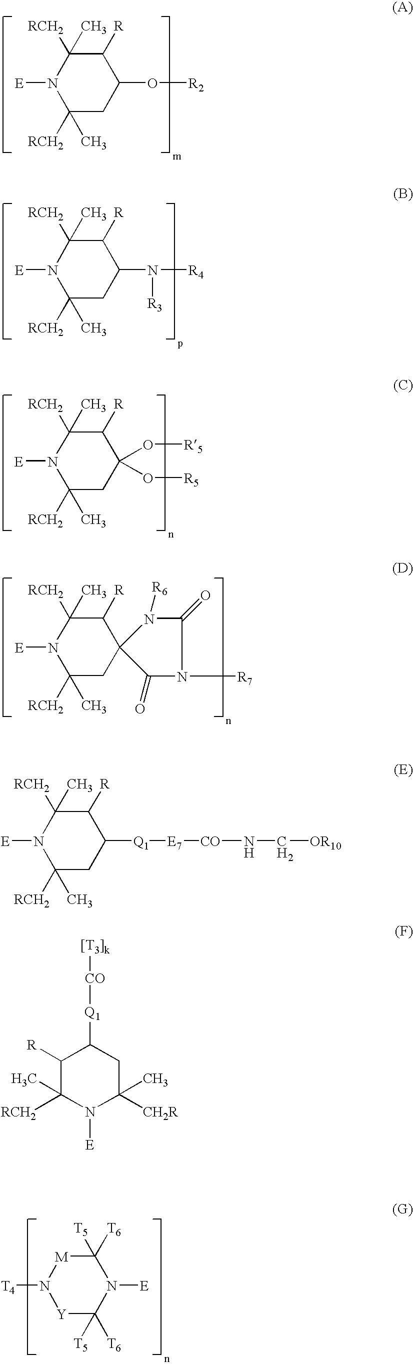 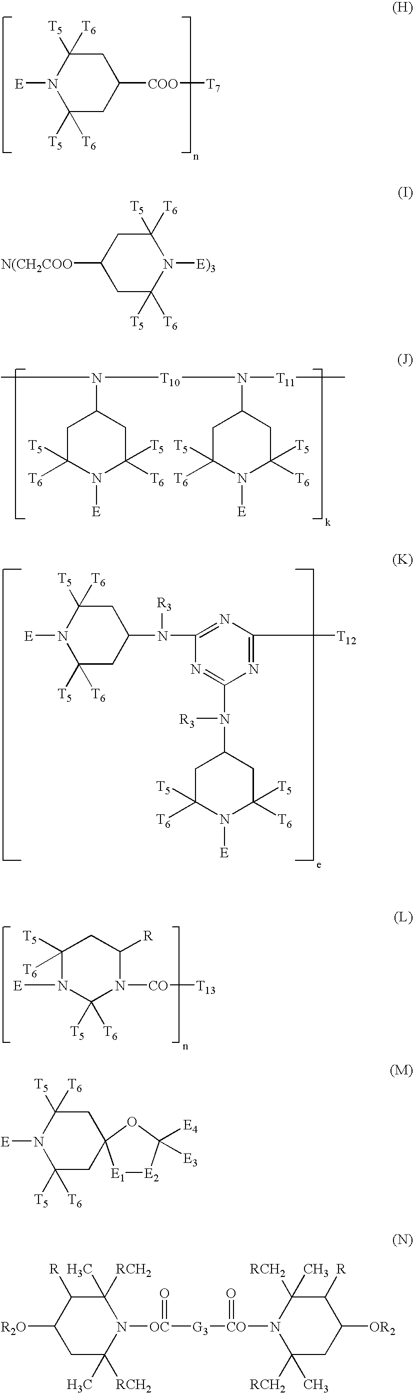 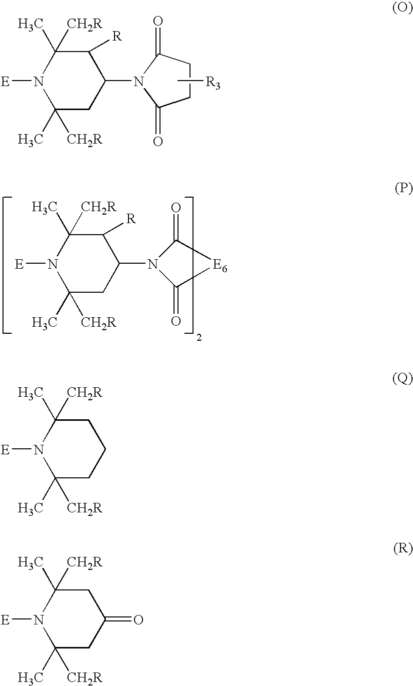
E is hydrogen, oxyl, hydroxy, alkyl with 1-8 carbon atoms, alkenyl with 1-8 carbon atoms, cycloalkyl, aryl, alkoxy of 1 to 18 carbon atoms, cycloalkoxy of 5 to 12 carbon atoms or aralkoxy of 7 to 15 carbon atoms, or —O-T-(OH)_{b} or substituted aryl.
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl,
m is 1 to 4,
when m is 1,
R₂ is hydrogen, C₁-C₁₈alkyl or said alkyl optionally interrupted by one or more oxygen atoms, C₂-C₁₂alkenyl, C₆-C₁₀aryl, C₇-C₁₈aralkyl, glycidyl, a monovalent acyl radical of an aliphatic,cycloaliphatic or aromatic carboxylic acid, or a carbamic acid, for example an acyl radical of an aliphatic carboxylic acid having 2-18 C atoms, of a cyclo-aliphatic carboxylic acid having 5-12 C atoms or of an aromatic carboxylic acid having 7-15 C atoms, or 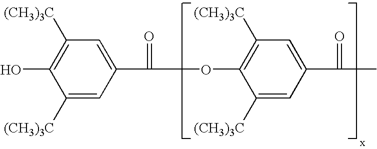
wherein x is 0 or 1, 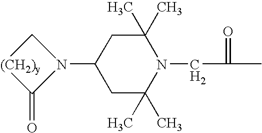
wherein y is 2-4;
when m is 2,
R₂ is C₁-C₁₂alkylene, C₄-C₁₂alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 C atoms, of a cycloaliphatic or aromatic dicarboxylic acid having 8-14 C atoms, or of an aliphatic, cycloaliphatic or aromatic dicarbamic acid having 8-14 C atoms; 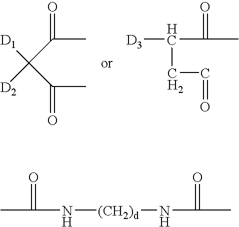
wherein D₁ and D₂ are independently hydrogen, an alkyl radical containing up to 8 carbon atoms, an aryl or aralkyl radical including 3,5-di-t-butyl-4-hydroxybenzyl radical, D₃ is hydrogen, or an alkyl or alkenyl radical containing up to 18 carbon atoms, and d is 0-20;
when m is 3, R₂ is a trivalent acyl radical of an aliphatic, unsaturated aliphatic, cycloaliphatic, or aromatic tricarboxylic acid;
when m is 4, R₂ is a tetravalent acyl radical of a saturated or unsaturated aliphatic or aromatic tetracarboxylic acid including 1,2,3,4-butanetetracarboxylic acid, 1,2,3,4-but-2-enetetracarboxylic , and 1,2,3,5- and 1,2,4,5-pentanetetracarboxylic acid;
p is 1, 2or 3,
R₃ is hydrogen, C₁-C₁₂alkyl, C₅-C₇cycloalkyl, C₇-C₉aralkyl, C₂-C₁₈alkanoyl, C₃-C₅alkenoyl or benzoyl;
when p is 1,
R₄ is hydrogen, C₁-C₁₈alkyl, C₅-C₇cycloalkyl, C₂-C₈alkenyl, unsubstituted or substituted by a cyano, carbonyl or carbamide group, aryl, aralkyl, or it is glycidyl, a group of the formula —CH₂—CH(OH)-Z or of the formula —CO-Z or —CONH-Z wherein Z is hydrogen, methyl or phenyl; or a group of the formulae 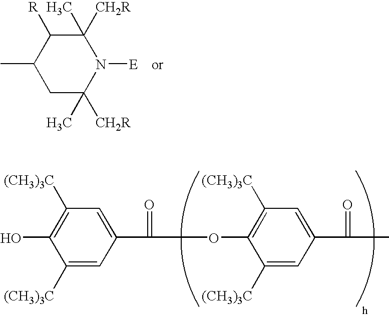
where h is 0 or 1,
R₃ and R₄ together, when p is 1, can be alkylene of 4 to 6 carbon atoms or 2-oxo-polyalkylene the cyclic acyl radical of an aliphatic or aromatic 1,2- or 1,3-dicarboxylic acid,
when p is 2,
R₄ is a direct bond or is C₁-C₁₂alkylene, C₆-C₁₂arylene, xylylene, a —CH₂CH(OH)—CH₂ group or a group —CH₂—CH(OH)—CH₂—O-X-O—CH₂—CH(OH)—CH₂— wherein X is C₂-C₁₀-alkylene, C₆-C₁₅arylene or C₆-C₁₂cycloalkylene; or, provided that R₃ is not alkanoyl, alkenoyl or benzoyl, R₄ can also be a divalent acyl radical of an aliphatic, cycloaliphatic or aromatic dicarboxylic acid or dicarbamic acid, or can be the group —CO—; or
R₄ is 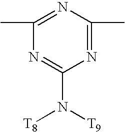
where T₈ and T₉ are independently hydrogen, alkyl of 1 to 18 carbon atoms, or T₈ and T₉ together are alkylene of 4 to 6 carbon atoms or 3-oxapentamethylene, for instance T₈ and T₉ together are 3-oxapentamethylene;
when p is 3,
R₄ is 2,4,6-triazinyl,
n is 1 or 2,
when n is 1,
R₅ and R′₅ are independently C₁-C₁₂ alkyl, C₂-C₁₂ alkenyl, C₇-C₁₂ aralkyl, or R₅ is also hydrogen, or R₅ and R′₅ together are C₂-C₈alkylene or hydroxyalkylene or C₄-C₂₂acyloxyalkylene;
when n is 2,
R₅ and R′₅ together are (—CH₂)₂C(CH₂—)₂;
R₆ is hydrogen, C₁-C₁₂alkyl, allyl, benzyl, glycidyl or C₂-C₆alkoxyalkyl;
when n is 1,
R₇ is hydrogen, C₁-C₁₂alkyl, C₃-C₅alkenyl, C₇-C₉aralkyl, C₅-C₇cycloalkyl, C₂-C₄hydroxyalkyl, C₂-C₆alkoxyalkyl, C₆-C₁₀aryl, glycidyl, a group of the formula —(CH₂)ₜ—COO-Q or of the formula —(CH₂)ₜ—O—CO-Q wherein t is 1 or 2, and Q is C₁-C₄alkyl or phenyl; or
when n is 2,
R₇ is C₂-C₁₂alkylene, C₆-C₁₂arylene, a group —CH₂CH(OH)—CH₂—O-X-O—CH₂-CH(OH)—CH₂— wherein X is C₂-C₁₀alkylene, C₆-C₁₅arylene or C₆-C₁₂cycloalkylene, or a group —CH₂CH(OZ′)CH₂—(OCH₂—CH(OZ′)CH₂)₂— wherein Z′ is hydrogen, C₁-C₁₈alkyl, allyl, benzyl, C₂-C₁₂alkanoyl or benzoyl;
Q₁ is —N(R₈)— or —O—; E₇ is C₁-C₃ alkylene, the group —CH₂—CH(R₉)—O— wherein R₉ is hydrogen, methyl or phenyl, the group —(CH₂)₃—NH— or a direct bond;
R₁₀ is hydrogen or C₁-C₁₈ alkyl, R₈ is hydrogen, C₁-C₁₈alkyl, C₅-C₇cycloalkyl, C₇-C₁₂aralkyl, cyanoethyl, C₆-C₁₀aryl, the group —CH₂—CH(R₉)—OH wherein R₉ has the meaning defined above; a group of the formula 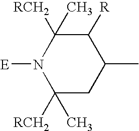
or a group of the formula 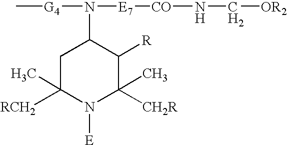
wherein G₄ is C₂-C₆alkylene or C₆-C₁₂arylene; or R₈ is a group -E₇-CO—NH—CH₂—OR₁₀;
Formula F denotes a recurring structural unit of a polymer where T₃ is ethylene or 1,2-propylene, is the repeating structural unit derived from an alpha-olefin copolymer with an alkyl acrylate or methacrylate; for example a copolymer of ethylene and ethyl acrylate, and where k is 2 to 100;
T₄ has the same meaning as R₄ when p is 1 or 2,
T₅ is methyl,
T₆ is methyl or ethyl, or T₅ and T₆ together are tetramethylene or pentamethylene, for instance T₅ and T₆ are each methyl,
M and Y are independently methylene or carbonyl, and T₄ is ethylene where n is 2;
T₇ is the same as R₇, and T₇ is for example octamethylene where n is 2,
T₁₀ and T₁₁ are independently alkylene of 2 to 12 carbon atoms, or T₁₁ is 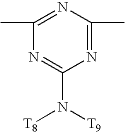
T₁₂ is piperazinyl,
—NR₁₁—(CH₂)_{d}—NR₁₁— or 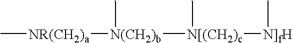
where R₁₁ is the same as R₃ or is also 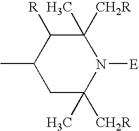
a, b and c are independently 2 or 3, and f is 0 or 1, for instance a and c are each 3, b is 2 and f is 1; and
e is 2, 3 or 4, for example 4;
T₁₃ is the same as R₂ with the proviso that T₁₃ cannot be hydrogen when n is 1;
E₁ and E₂, being different, each are —CO— or —N(E₅)- where E₅ is hydrogen, C₁-C₁₂ alkyl or C₄-C₂₂ alkoxycarbonylalkyl, for instance E₁ is —CO— and E₂ is —N(E₅)-,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 o 12 carbon atoms, or
E₃ and E₄ together are polymethylene of 4 to 17 carbon atoms, or said polymethylene substituted by up to four alkyl groups of 1 to 4 carbon atoms, for example methyl,
E₆ is an aliphatic or aromatic tetravalent radical,
R₂ of formula (N) is a previously defined when m is 1;
G₁ a direct bond, C₁-C₁₂ alkylene, phenylene or —NH-G′—NH wherein G′ is C₁-C₁₂ alkylene; or
wherein the hindered amine compound is a compound of the formula I, II, III, IV, V, VI, VII, VIII, IX, X or XI 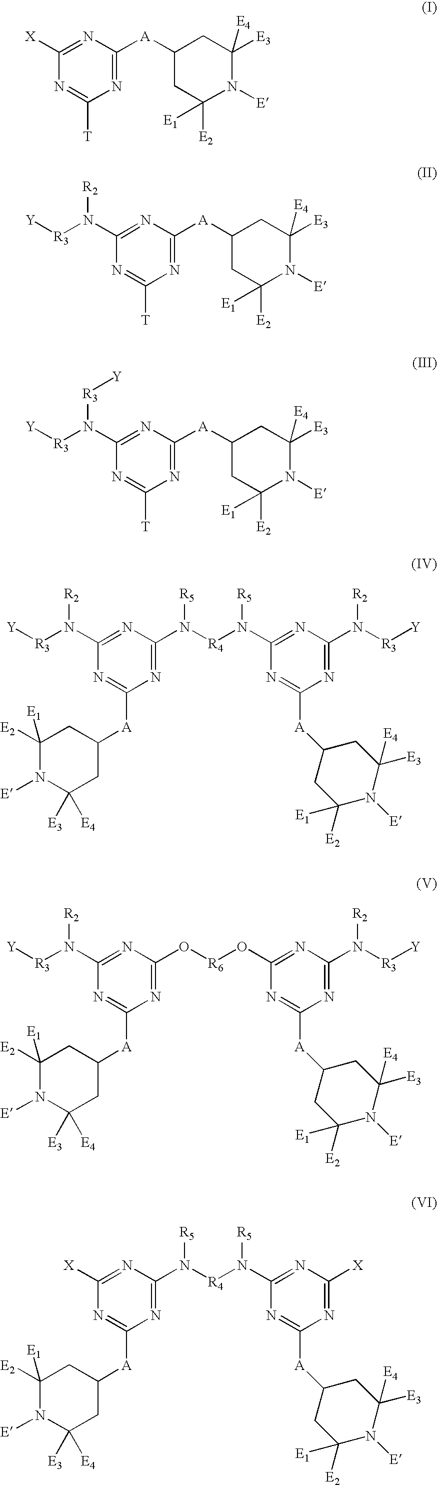 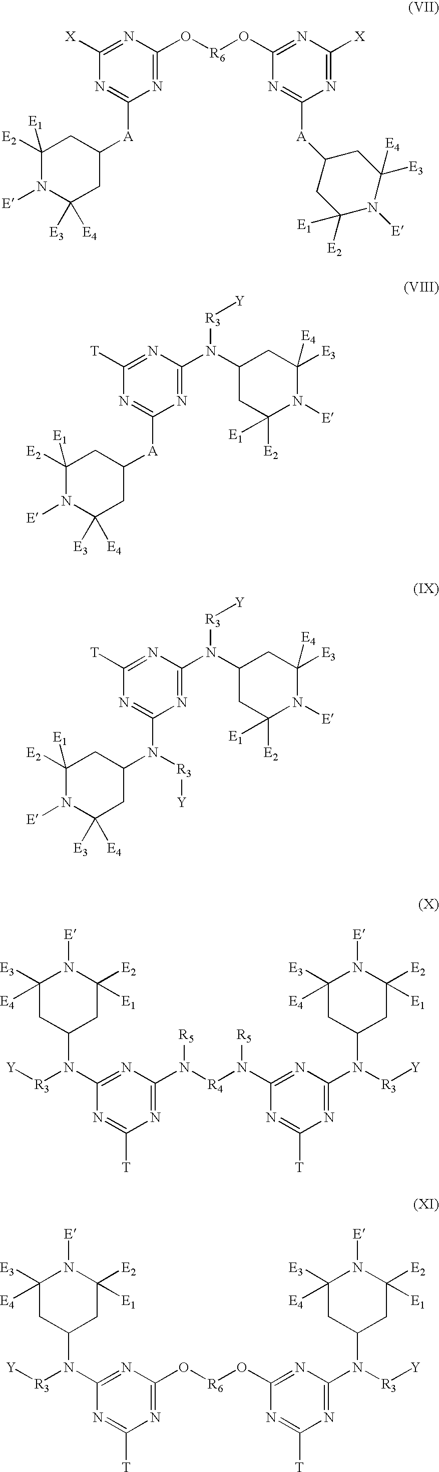
wherein
E₁, E₂, E₃ and E₄ are independently alkyl of 1 to 4 carbon atoms, or E₁ and E₂ are independently alkyl of 1 to 4 carbon atoms and E₃ and E₄ taken together are pentamethylene, or E₁ and E₂; and E₃ and E₄ each taken together are pentamethylene,
E′ is hydrogen, oxyl, hydroxy, alkyl with 1-8 carbon atoms, alkenyl with 2-8 carbon atoms, cycloalkyl, aryl, alkoxy of 1-18 carbon atoms, cycloalkoxy of 5 to 12 carbon atoms or aralkoxy of 7 to 15 carbon atoms, or —O-T-(OH)_{b} or substituted aryl.
T and b defined as above.
R₂ is hydrogen or a linear or branched chain alkyl of 1 to 12 carbon atoms,
R₃ is alkylene of 1 to 8 carbon atoms, or R₃ is —CO—, —CO—R₄—, —CONR₂—, or —CO—NR₂—R₄—,
R₄ is alkylene of 1 to 8 carbon atoms,
R₅ is hydrogen, a linear or branched chain alkyl of 1 to 12 carbon atoms, or 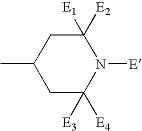
or when R₄ is ethylene, two R₅ methyl substituents can be linked by a direct bond so that the triazine bridging group —N(R₅)—R₄—N(R₅)— is a piperazin-1,4-diyl moiety,
R₆ is alkylene of 2 to 8 carbon atoms or R₆ is 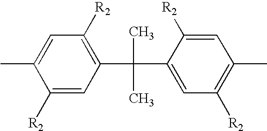
with the proviso that Y is not —OH when R₆ is the structure depicted above,
A is —O— or —NR₇— where R₇ is hydrogen, a straight or branched chain alkyl of 1 to 12 carbon atoms, or R₇ is 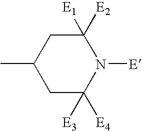
T is phenoxy, phenoxy substituted by one or two alkyl groups of 1 to 4 carbon atoms, alkoxy of 1 to 8 carbon atoms or —N(R₂)₂ with the stipulation that R₂ is not hydrogen, or T is 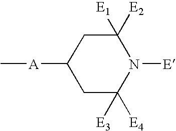
X is —NH₂, —NCO, —OH, —O-glycidyl, or —NHNH₂, and
Y is —OH, —NH₂, —NHR₂ where R₂ is not hydrogen; or Y is —NCO, —COOH, oxiranyl, —O-glycidyl, or —Si(OR₂)₃; or the combination R₃—Y— is —CH₂CH(OH)R₂ where R₂ is alkyl or said alkyl interrupted by one to four oxygen atoms, or R₃—Y— is —CH₂OR₂;
or
wherein the hindered amine compound is a mixture of N,N′,N′″-tris{2,4-bis[(1-hydrocarbyloxy-2,2,6,6-tetramethylpiperidin-4-yl)alkylamino]-s-triazin-6-yl}-3,3′-ethylene-diiminodipropylamine; N,N′, N″-tris{2,4-bis[(1-hydrocarbyloxy-2,2,6,6-tetramethylpiperidin-4-yl)alkylamino]-s-triazin-6-yl}-3,3′-ethylenediiminodipropylamine, and bridged derivatives as described by formulas I, II, IIA and III
R₁NH—CH₂CH₂CH₂NR₂CH₂CH₂NR₃CH₂CH₂CH₂NHR₄ (I)
T-E₁-T₁ (II)
T-E₁ (IIA)
G-E₁-G₁-E₁-G₂ (III)
where in the tetraamine of formula I
R₁ and R₂ are the s-triazine moiety E; and one of R₃ and R₄ is the s-triazine moiety E with the other of R₃ or R₄ being hydrogen,
E is 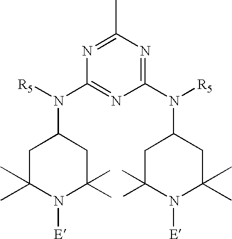
R is methyl, propyl, cyclohexyl or octyl,
R₅ is alkyl of 1 to 12 carbon atoms,
where in the compound of formula II or IIA when R is propyl, cyclohexyl or octyl,
T and T₁ are each a tetraamine substituted by R₁-R₄ as is defined for formula I,
where
(1) one of the s-triazine moieties E in each tetraamine is replaced by the group E₁ which forms a bridge between two tetraamines T and T₁,
E₁ is 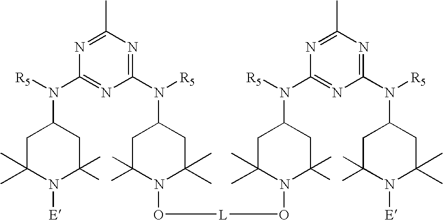
or
(2) the group E₁ can have both termini in the same tetraamine T as in formula IIA where two of the E moieties of the tetraamine are replaced by one E₁ group, or
(3) all three s-triazine substituents of tetraamine T can be E₁ such that one E₁ links T and T₁ and a second E₁ has both termini in tetraamine T,
L is propanediyl, cyclohexanediyl or octanediyl;
where in the compound of formula III
G, G₁ and G₂ are each tetraamines substituted by R₁-R₄ as defined for formula I, except that G and G₂ each have one of the s-triazine moieties E replaced by E₁, and G₁ has two of the triazine moieties E replaced by E₁, so that there is a bridge between G and G₁ and a second bridge between G₁ and G₂;
which mixture is prepared by reacting two to four equivalents of 2,4-bis[(1-hydro-carbyloxy-2,2,6,6-piperidin-4-yl)butylamino]-6-chloro-s-triazine with one equivalent of N,N′-bis(3-aminopropyl)ethylenediamine;
or the hindered amine is a compound of the formula IIIb 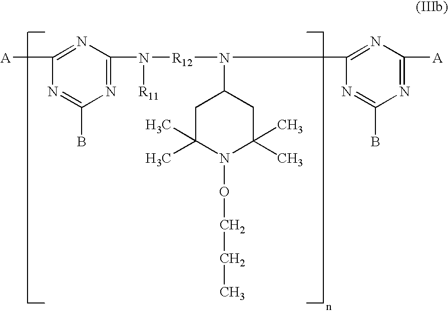
in which the index n ranges from 1 to 15;
R₁₂ is C₂-C₁₂alkylene, C₄-C₁₂alkenylene, C₅-C₇cycloalkylene, C₅-C₇cycloalkylene-di(C₁-C₄alkylene), C₁-C₄alkylenedi(C₅-C₇cycloalkylene), phenylenedi(C₁-C₄alkylene) or C₄-C₁₂alkylene interrupted by 1,4-piperazinediyl, —O— or >N—X₁ with X₁ being C₁-C₁₂acyl or (C₁-C₁₂alkoxy)carbonyl or having one of the definitions of R₁₄ given below except hydrogen; or R₁₂ is a group of the formula (Ib′) or (Ic′); 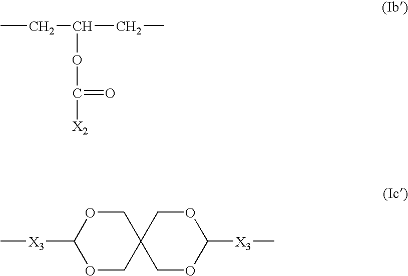
with m being 2 or 3,
X₂ being C₁-C₁₈alkyl, C₅-C₁₂cycloalkyl which is unsubstituted or substituted by 1, 2 or 3
C₁-C₄alkyl; phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; and
the radicals X₃ being independently of one another C₂-C₁₂alkylene;
R₁₃, R₁₄ and R₁₅, which are identical or different, are hydrogen, C₁-C₁₈alkyl, C₅-C₁₂cycloalkyl which is unsubstituted or substituted by 1, 2 or 3 C₁-C₄alkyl; C₃-C₁₈alkenyl, phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; tetrahydrofurfuryl or
C₂-C₄alkyl which is substituted in the 2, 3 or 4 position by —OH, C₁-C₈alkoxy, di(C₁-C₄alkyl)amino or a group of the formula (Ie′); 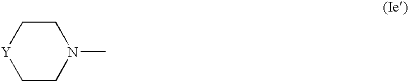
with Y being —O—, —CH₂—, —CH₂CH₂— or >N—CH₃,
or —N(R₁₄)(R₁₅) is additionally a group of the formula (Ie′);
the radicals A are independently of one another —OR₁₃, —N(R₁₄)(R₁₅) or a group of the formula (IIId); 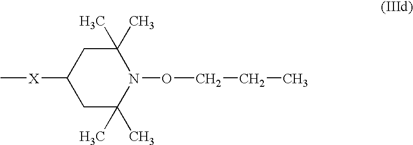
X is —O— or >N—R₁₆;
R₁₆ is hydrogen, C₁-C₁₈alkyl, C₃-C₁₈alkenyl, C₅-C₁₂cycloalkyl which is unsubstituted or substituted by 1, 2 or 3 C₁-C₄alkyl; C₇-C₉phenylalkyl which is unsubstituted or substituted on the phenyl by 1, 2 or 3 C₁-C₄alkyl; tetrahydrofurfuryl, a group of the formula (IIIf), 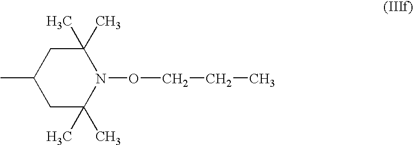
or C₂-C₄alkyl which is substituted in the 2, 3 or 4 position by —OH, C₁-C₈alkoxy, di(C₁-C₄alkyl)amino or a group of the formula (Ie′);
R₁₁ has one of the definitions given for R₁₆; and
the radicals B have independently of one another one of the definitions given for A.

9. A pigmented polystyrene foam composition according to claim 8 wherein at least one low molecular weight hindered amine light stabilizer component (c) is selected from the group consisting of
4-hydroxy-2,2,6,6-tetramethylpiperidine, 1-allyl-4-hydroxy-2,2,6,6-tetramethylpiperidine,
1-benzyl-4-hydroxy-2,2,6,6-tetramethylpiperidine, bis(2,2,6,6-tetramethyl4-piperidyl) sebacate, bis(2,2,6,6-tetramethyl-4-piperidyl) succinate,
bis(1,2,2,6,6-pentamethyl-4-piperidyl) sebacate,
bis(1-octyloxy-2,2,6,6-tetramethyl-4-piperidyl) sebacate,
bis(1,2,2,6,6-pentamethyl-4-piperidyl) n-butyl-3,5-di-tert-butyl-4-hydroxybenzylmalonate,
tris(2,2,6,6-tetramethyl-4-piperidyl) nitrilotriacetate,
tetrakis(2,2,6,6-tetramethyl-4-piperidyl)-1,2,3,4-butane-tetracarboxylate,
1,1′-(1,2-ethanediyl)-bis(3,3,5,5-tetramethylpiperazinone),
4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)
malonate, 3-n-octyl-7,7,9,9-tetramethyl-1,3,8-triazaspiro[4.5]decan-2,4-dione,
bis(1-octyloxy-2,2,6,6-tetramethylpiperidyl) sebacate,
bis(1-octyloxy-2,2,6,6-tetramethylpiperidyl) succinate,
8-acetyl-3-dodecyl-7,7,9,9-tetramethyl-1,3,8-triazaspiro[4.5]decane-2,4-dione,
3-dodecyl-1-(2,2,6,6-tetramethyl-4-piperidyl)pyrrolidin-2,5-dione,
3-dodecyl-1-(1,2,2,6,6-pentamethyl-4-piperidyl)pyrrolidine-2,5-dione,
a mixture of 4-hexadecyloxy- and 4-stearyloxy-2,2,6,6-tetramethylpiperidine,
N-(2,2,6,6-tetramethyl-4-piperidyl)-n-dodecylsuccinimide,
N-(1,2,2,6,6-pentamethyl-4-piperidyl)-n-dodecylsuccinimide,
2-undecyl-7,7,9,9-tetramethyl-1-oxa-3,8-diaza-4-oxo-spiro[4,5]decane,
1,1-bis(1,2,2,6,6-pentamethyl-4-piperidyloxycarbonyl)-2-(4-methoxyphenyl)ethene,
N,N′-bis-formyl-N,N′-bis(2,2,6,6-tetramethyl-4-piperidyl)hexamethylenediamine,
diester of 4-methoxy-methylene-malonic acid with 1,2,2,6,6-pentamethyl-4-hydroxypiperidine.

10. A pigmented polystyrene foam according to claim 9 wherein at least one low molecular weight hindered amine light stabilizer component (c ) is selected from the group consisting of
4-hydroxy-2,2,6,6-tetramethylpiperidine, 1-allyl-4-hydroxy-2,2,6,6-tetramethylpiperidine,
1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate,
bis(1-octyloxy-2,2,6,6-tetramethyl-4-piperidyl) sebacate,
tetrakis(2,2,6,6-tetramethyl-4-piperidyl)-1,2,3,4-butane-tetracarboxylate,
4-benzoyl-2,2,6,6-tetramethylpiperidine,
4-stearyloxy-2,2,6,6-tetramethylpiperidine,bis(1-octyloxy-2,2,6,6-tetramethylpiperidyl) sebacate,
bis(1-octyloxy-2,2,6,6-tetramethylpiperidyl) succinate,
a mixture of 4-hexadecyloxy- and 4-stearyloxy-2,2,6,6-tetramethylpiperidine, N-(2,2,6,6-tetramethyl-4-piperidyl)-n-dodecylsuccinimide, N-(1,2,2,6,6-pentamethyl-4-piperidyl)-n-dodecylsuccinimide,
1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, and diester of 4-methoxy-methylene-malonic acid with 1,2,2,6,6-pentamethyl-4-hydroxypiperidine.

11. A pigmented polystyrene foam according to claim 8 wherein the component (d) is selected from at least one high molecular weight hindered amine light stabilizer of the group consisting of
linear or cyclic condensates of N,N′-bis(2,2,6,6-tetramethyl-4-piperidyl)hexamethylenediamine and 4-tert-octylamino-2,6-dichloro-1,3,5-triazine [CHIMASSORB 944],
linear or cyclic condensates of N,N′-bis-(2,2,6,6-tetramethyl-4-piperidyl)-hexamethylenediamine and 4-morpholino-2,6-dichloro-1,3,5-triazine [CYASORB UV-3346],
a condensation product of N,N′-bis(2,2,6,6-tetramethyl-4-piperidyl)hexamethylenediamine and 4-cyclohexylamino-2,6-dichloro-1,3,5-triazine,
1,6-Hexanediamine, N,N′-bis(2,2,6,6-tetramethyl-4-piperidinyl)-, polymers with morpholine-2,4,6-trichloro-1,3,5-triazine reaction products, methylated [CYASORB UV-3529],
1,6-Hexanediamine, N ,N′-bis(2,2,6,6-tetramethyl-4-piperidinyl)—, polymer with 2,4,6-trichloro-1,3,5-triazine, reaction products with,N-butyl-1-butanamine and N-butyl-2,2,6,6-tetramethyl-4-piperidinamine [CHIMASSORB 2020],
1,3-Propanediamine, N,N″-1,2-ethanediylbis-, polymer with 2,4,6-trichloro-1,3,5-triazine, reaction products with N-butyl-2,2,6,6-tetramethyl-4-piperidinamine [UVASORB HA 88],
2,4,8,10-Tetraoxaspiro[5.5]undecane-3,9-diethanol, β,β,β′,β′-tetramethyl-, polymer with 1,2,3,4-butanetetracarboxylic acid, 1,2,2,6,6-pentamethyl-4-piperidinyl ester [ADK STAB LA 63],
1,3,5-Triazine-2,4,6-triamine, N,N′″-1,2-ethanediylbis[N-[3-[[4,6- bis[butyl(1,2,2,6,6-pentamethyl-4-piperidinyl)amino]-1,3,5-triazin-2-yl]amino]propyl]-N′,N″-dibutyl-N′,N″-bis(1,2,2,6,6-pentamethyl-4-piperidinyl)-[CHIMASSORB 119],
1,2,3,4-Butanetetracarboxylic acid-β,β,β′,β′- tetramethyl-2,4,8,10-tetraoxaspiro[5.5]undecane-3,9-diethanol copolymer,2,2,6,6-tetramethyl-4-piperidinyl ester [ADK STAB LA 68], and
1,6-Hexanediamine, N,N′-bis(2,2,6,6-tetramethyl-4-piperidinyl)—, polymer with 2,4-dichloro-6-(4-morpholinyl)-1,3,5-triazine [CYASORB UV-3346].

12. A composition according to claim 7 wherein the total ratio of the weight of components (c)+(d) to total weight of component (e) is from about 3:1 to about 1:3.

13. A composition according to claim 1 wherein the ratio of the weight of component (b) light absorber or mixtures of light absorbers to total weight of components (c)+(d) is from about 3:1 to about 1:3.

14. A pigmented polystyrene foam according to claim 1 wherein the pigment or pigment mixtures of component (e) are selected from the group consisting of
Pigment Black 7, Pigment Black 11, Pigment Black 12, Pigment Black 26, Pigment Black 27, Pigment Black 28, Pigment Black 30, Pigment Blue 7, Pigment Blue 15.1, Pigment Blue 15.3, Pigment 15:4, Pigment 15:2, Pigment Blue 28, Pigment Blue 29, Pigment Blue 36, Pigment Blue 60, Pigment Brown 11, Pigment Brown 23, Pigment Brown 24, Pigment Brown 33, Pigment Brown 35, Pigment Green 17, Pigment Green 26, Pigment Green 36, Pigment Green 50, Pigment Green 7, Pigment Red 104, Pigment Red 110, Pigment Red 122, Pigment Red 101, Pigment Red 178, Pigment Red 202, Pigment Red 254, Pigment Red 149, Pigment Red 108, Pigment Violet 14, Pigment Violet 15, Pigment Violet 16, Pigment Violet 19, Pigment Violet 23, Pigment Violet 29, Pigment Violet 37, Pigment Violet 47, Pigment Yellow 37, Pigment Violet 48, Pigment Yellow 53, Pigment Yellow 110, Pigment Yellow 119, Pigment Yellow 161, Pigment Yellow 162, Pigment Yellow 163, Pigment Yellow 164, Pigment Yellow 184, Pigment Yellow 199, Pigment Yellow 215, Pigment Yellow 34, Pigment Yellow 35, Pigment Orange 61, Chromothal Yellow 382 EOB, Pigment Orange 20, Pigment White 21, Pigment White 22, Pigment White 4, Pigment White 5, Pigment White 7, and Pigment White 6.

15. A pigmented polystyrene foam according to claim 14 wherein the pigment or pigment mixtures of component (e) are selected from the group consisting of
Pigment White 6, Pigment Black 7, Pigment Red 101, Pigment Yellow 184, Pigment Brown 24, Pigment Blue 15:1, Pigment Blue 15:3, Pigment Blue 7, Pigment Yellow 215, Pigment Yellow 110, Pigment Red 202, Pigment Violet 19, Pigment Red 149, Pigment Red 122, Pigment Yellow 119 and Pigment Black 27.

16. A pigmented polystyrene foam compostion according to claim 1 comprising
(a) a foam polystyrene homopolymer or copolymer,
(b) at least one compound selected from the group consisting of
2-(2-hydroxyphenyl)-2H-benxotriazoles, 2-Hydroxybenzophenones, esters of substituted and unsubstituted benzoic acids, acrylates and malonates, oxamides, and tris-aryl-o-hydroxyphenyl-s-triazines.
(c) at least one low molecular weight hindered amine light stabilizer selected from the group consisting of
4-hydroxy-2,2,6,6-tetramethylpiperidine, 1-allyl-4-hydroxy-2,2,6,6-tetramethylpiperidine,
1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate,
bis(1,2,2,6,6-pentamethyl-4-piperidyl) sebacate,
bis(1-octyloxy-2,2,6,6-tetramethyl-4-piperidyl) sebacate,
bis(1,2,2,6,6-pentamethyl-4-piperidyl) n-butyl-3,5-di-tert-butyl-4-hydroxybenzylmalonate,
tris(2,2,6,6-tetramethyl-4-piperidyl) nitrilotriacetate,
tetrakis(2,2,6,6-tetramethyl-4-piperidyl)-1,2,3,4-butane-tetracarboxylate,
1,1′-(1,2-ethanediyl)-bis(3,3,5,5-tetramethylpiperazinone),
4-benzoyl-2,2,6,6-tetramethylpiperidine, 4-stearyloxy-2,2,6,6-tetramethylpiperidine,
bis(1,2,2,6,6-pentamethylpiperidyl)-2-n-butyl-2-(2-hydroxy-3,5-di-tert-butylbenzyl)
malonate, 3-n-octyl-7,7,9,9-tetramethyl-1,3,8-triazaspiro[4.5]decan-2,4-dione,
bis(1-octyloxy-2,2,6,6-tetramethylpiperidyl) sebacate,
bis(1-octyloxy-2,2,6,6-tetramethylpiperidyl) succinate,
8-acetyl-3-dodecyl-7,7,9,9-tetramethyl-1,3,8-triazaspiro[4.5]decane-2,4-dione,
3-dodecyl-1-(2,2,6,6-tetramethyl-4-piperidyl)pyrrolidin-2,5-dione,
3-dodecyl-1-(1,2,2,6,6-pentamethyl-4-piperidyl)pyrrolidine-2,5-dione,
a mixture of 4-hexadecyloxy- and 4-stearyloxy-2,2,6,6-tetramethylpiperidine,
N-(2,2,6,6-tetramethyl-4-piperidyl)-n-dodecylsuccinimide,
N-(1,2,2,6,6-pentamethyl-4-piperidyl)-n-dodecylsuccinimide,
2-undecyl-7,7,9,9-tetramethyl-1-oxa-3,8-diaza-4-oxo-spiro[4,5]decane,
1,1-bis(1,2,2,6,6-pentamethyl-4-piperidyloxycarbonyl)-2-(4-methoxyphenyl)ethene,
N,N′-bis-formyl-N,N′-bis(2,2,6,6-tetramethyl-4-piperidyl)hexamethylenediamine and diester of 4-methoxy-methylene-malonic acid with 1,2,2,6,6-pentamethyl-4-hydroxypiperidine.
(d) at least one high molecular weight hindered amine light stabilizer selected from the group consisting of
linear or cyclic condensates of N,N′-bis(2,2,6,6-tetramethyl-4-piperidyl)hexamethylenediamine and 4-tert-octylamino-2,6-dichloro-1,3,5-triazine [CHIMASSORB 944],
linear or cyclic condensates of N,N′-bis-(2,2,6,6-tetramethyl-4-piperidyl)-hexamethylenediamine and 4-morpholino-2,6-dichloro-1,3,5-triazine [CYASORB UV-3346],
a condensation product of N,N′-bis(2,2,6,6-tetramethyl4-piperidyl)hexamethylenediamine and 4-cyclohexylamino-2,6-dichloro-1,3,5-triazine,
1,6-Hexanediamine, N,N′-bis(2,2,6,6-tetramethyl4-piperidinyl)—, polymers with morpholine-2,4,6-trichloro-1,3,5-triazine reaction products, methylated [CYASORB UV-3529],
1,6-Hexanediamine, N,N′-bis(2,2,6,6-tetramethyl-4-piperidinyl)—, polymer with 2,4,6-trichloro-1,3,5-triazine, reaction products with,N-butyl-1-butanamine and N-butyl-2,2,6,6-tetramethyl-4-piperidinamine [CH IMASSORB 2020],
1,3-Propanediamine, N,N″-1,2-ethanediylbis-, polymer with 2,4,6-trichloro-1,3,5-triazine, reaction products with N-butyl-2,2,6,6-tetramethyl-4-piperidinamine [UVASORB HA 88],
2,4,8,10-Tetraoxaspiro[5.5]undecane-3,9-diethanol,
β,β,β′,β′-tetramethyl—, polymer with 1,2,3,4-butanetetracarboxylic acid, 1,2,2,6,6-pentamethyl-4-piperidinyl ester [ADK STAB LA 63],
1,3,5-Triazine-2,4,6-triamine, N,N′″-1,2-ethanediylbis[N-[3-[[4,6- bis[butyl(1,2,2,6,6-pentamethyl-4-piperidinyl)amino]-1,3,5-triazin-2-yl]amino]propyl]-N′,N″-dibutyl-N″,N″-bis(1,2,2,6,6-pentamethyl-4-piperidinyl)-[CHIMASSORB 119],
1,2,3,4-Butanetetracarboxylic acid-β,β,β′,β′-tetramethyl-2,4,8,10-tetraoxaspiro[5.5]undecane-3,9-diethanol copolymer,2,2,6,6-tetramethyl-4-piperidinyl ester [ADK STAB LA 68], and
1,6-Hexanediamine, N,N′-bis(2,2,6,6-tetramethyl-4-piperidinyl)—, polymer with 2,4-dichloro-6-(4-morpholinyl)-1,3,5-triazine [CYASORB UV-3346];
(e) at least one pigment selected from the group consisting of
Pigment Black 7, Pigment Black 11, Pigment Black 12, Pigment Black 26, Pigment Black 27, Pigment Black 28, Pigment Black 30, Pigment Blue 7, Pigment Blue 15.1, Pigment Blue 15.3, Pigment 15:4, Pigment 15:2, Pigment Blue 28, Pigment Blue 29, Pigment Blue 36, Pigment Blue 60, Pigment Brown 11, Pigment Brown 23, Pigment Brown 24, Pigment Brown 33, Pigment Brown 35, Pigment Green 17, Pigment Green 26, Pigment Green 36, Pigment Green 50, Pigment Green 7, Pigment Red 104, Pigment Red 110, Pigment Red 122, Pigment Red 101, Pigment Red 178, Pigment Red 202, Pigment Red 254, Pigment Red 149, Pigment Red 108, Pigment Violet 14, Pigment Violet 15, Pigment Violet 16, Pigment Violet 19, Pigment Violet 23, Pigment Violet 29, Pigment Violet 37, Pigment Violet 47, Pigment Yellow 37, Pigment Violet 48, Pigment Yellow 53, Pigment Yellow 110, PigmentYellow 119, Pigment Yellow 161, PigmentYellow 162, Pigment Yellow 163, Pigment Yellow 164, Pigment Yellow 184, Pigment Yellow 199, Pigment Yellow 215, Pigment Yellow 34, Pigment Yellow 35, Chromothal Yellow 382 EOB, Pigment Orange 61, Pigment Orange 20, Pigment White 21, Pigment White 22, Pigment White 4, Pigment White 5, Pigment White 7, and Pigment White 6, and
(f) optionally, carbon black.

17. A method of protecting pigmented polystyrene foam from discoloration when exposed to the influences of outdoor weathering comprising the steps of
(i) expressing a styrenic polymer or copolymer gel composition from a die so that the expressed gel expands into a cellular foam by the action of a blowing agent, said gel composition comprising
(a) a polystyrene homopolymer or copolymer
(b) at least one compound selected from an light absorber,
(c) at least one low molecular weight hindered amine light stabilizer,
(d) at least one high molecular weight hindered amine light stabilizer,
(e) at least one pigment, and
(f) optionally, carbon black, and
(ii) cooling the expanded polymer foam to a temperature at which said foam is self-supporting,
wherein the expanded polymer foam shows a Δ E color change when exposed under a Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0 , wherein Δ E color change is determined according to ASTM method D2244.

18. A composition according to claim 1 comprising a further component selected from the group consisting of plasticizers, phenolic antioxidants, phosphite and phosphonite stabilizers, slip agents, and mixtures thereof.

19. An additive combination for pigmenting polystyrene foam comprising
(b) at least one compound selected from an light absorber,
(c) at least one low molecular weight hindered amine light stabilizer,
(d) at least one high molecular weight hindered amine light stabilizer,
(e) at least one pigment or pigment mixture, and
(f) optionally, carbon black,
wherein the expanded polymer foam shows a Δ E color change when exposed under an Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0 , wherein Δ E color change is determined according to ASTM method D2244.

20. A molded or extruded polystyrene foam article comprising
(a) a foam polystyrene homopolymer or copolymer,
(b) at least one compound selected from an light absorber,
(c) at least one low molecular weight hindered amine light stabilizer,
(d) at least one high molecular weight hindered amine light stabilizer,
(e) at least one pigment or pigment mixture and
(f) optionally, carbon black
wherein the expanded polymer foam shows a Δ E color change when exposed under an Xenon Arc Weather-O-meter at 63° C. black panel temperature, 0.35 W/m² at 340 nanometers and 50% relative humidity with intermittent light/dark cycles and water spray (102 min. of light and 18 minutes of light plus water spray) over a period of 3000 hours of less than about 3.0, wherein Δ E color change is determined according to ASTM method D2244.

21. A molded or extruded polystyrene foam article according to claim 20 wherein the article is selected from the group consisting of fences, patio furniture, window boxes, window trim, mail boxes and planters.

22. A molded or extruded polystyrene foam article according to claim 20 comprising
(a) a foam polystyrene homopolymer or copolymer,
(b) at least one compound selected from the group consisting of
2-(2-hydroxyphenyl)-2H-benxotriazoles, 2-Hydroxybenzophenones, esters of substituted and unsubstituted benzoic acids, acrylates and malonates, oxamides, and tris-aryl-o-hydroxyphenyl-s-triazines.
(c) at least one low molecular weight hindered amine light stabilizer selected from the group consisting of
4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate,
bis(1,2,2,6,6-pentamethyl-4-piperidyl) sebacate,
bis(1-octyloxy-2,2,6,6-tetramethyl-4-piperidyl) sebacate,
bis(1,2,2,6,6-pentamethyl-4-piperidyl) n-butyl-3,5-di-tert-butyl4-hydroxybenzylmalonate, tris(2 ,2,6 ,6-tetramethyl4-piperidyl) nitrilotriacetate,
tetrakis(2,2,6,6-tetramethyl4-piperidyl)-1,2,3,4-butane-tetracarboxylate,
1, 1′-(1,2-ethanediyl)-bis(3,3,5,5-tetramethylpiperazinone),
4-benzoyl-2,2,6,6-tetramethylpiperidine, 4-stearyloxy-2,2,6,6-tetramethylpiperidine,
bis(1,2,2,6,6-pentamethylpiperidyl)-2-n-butyl-2-(2-hydroxy-3,5-di-tert-butylbenzyl) malonate, 3-n-octyl-7,7,9,9-tetramethyl-1,3,8-triazaspiro[4.5]decan-2,4-dione,
bis(1-octyloxy-2,2,6,6-tetramethylpiperidyl) sebacate,
bis(1-octyloxy-2,2,6,6-tetramethylpiperidyl) succinate,
8-acetyl-3-dodecyl-7,7,9,9-tetramethyl-1,3,8-triazaspiro[4.5]decane-2,4-dione,
3-dodecyl-1-(2,2,6,6-tetramethyl-4-piperidyl)pyrrolidin-2,5-dione,
3-dodecyl-1-(1,2,2,6,6-pentamethyl-4-piperidyl)pyrrolidine-2,5-dione,
a mixture of 4-hexadecyloxy- and 4-stearyloxy-2,2,6,6-tetramethylpiperidine,
N-(2,2,6,6-tetramethyl-4-piperidyl)-n-dodecylsuccinimide,
N-(1,2,2,6,6-pentamethyl-4-piperidyl)-n-dodecylsuccinimide,
2-undecyl-7,7,9,9-tetramethyl-1-oxa-3,8-diaza-4-oxo-spiro[4,5]decane,
1,1-bis(1,2,2,6,6-pentamethyl-4-piperidyloxycarbonyl)-2-(4-methoxyphenyl)ethene,
N N′-bis-formyl-N,N′-bis(2,2,6,6-tetramethyl-4-piperidyl)hexamethylenediamine,
diester of 4-methoxy-methylene-malonic acid with 1,2,2,6,6-pentamethyl-4-hydroxypiperidine;
(d) at least one high molecular weight hindered amine light stabilizer selected from the group consisting of
linear or cyclic condensates of N,N′-bis(2,2,6,6-tetramethyl-4-piperidyl)hexamethylenediamine and 4-tert-octylamino-2,6-dichloro-1,3,5-triazine [CHIMASSORB 944],
linear or cyclic condensates of N,N′-bis-(2,2,6,6-tetramethyl4-piperidyl)-hexamethylenediamine and 4-morpholino-2,6-dichloro-1,3,5-triazine [CYASORB UV-3346],
a condensation product of N,N′-bis(2,2,6,6-tetramethyl-4-piperidyl)hexamethylenediamine and 4-cyclohexylamino-2,6-dichloro-1,3,5-triazine,
1,6-Hexanediamine, N,N′-bis(2,2,6,6-tetramethyl-4-piperidinyl)-, polymers with morpholine-2,4,6-trichloro-1,3,5-triazine reaction products, methylated [CYASORB UV 3529],
1,6-Hexanediamine, N,N′-bis(2,2,6,6-tetramethyl-4-piperidinyl)—, polymer with 2,4,6-trichloro-1,3,5-triazine, reaction products with,N-butyl-1-butanamine and N-butyl-2,2,6,6-tetramethyl4-piperidinamine [CH I MASSORB 2020],
1,3-Propanediamine, N,N″-1,2-ethanediylbis-, polymer with 2,4,6-trichloro-1,3,5-triazine, reaction products with N-butyl-2,2,6,6-tetramethyl-4-piperidinamine [UVASORB HA 88],
2,4,8,10-Tetraoxaspiro[5.5]undecane-3,9-diethanol, β,β,β′,β′-tetramethyl-, polymer with 1,2,3,4-butanetetracarboxylic acid, 1,2,2,6,6-pentamethyl-4-piperidinyl ester [ADK STAB LA 63],
1,3,5-Triazine-2,4,6-triamine, N,N′″-1,2-ethanediylbis[N-[3-[[4,6- bis[butyl(1,2,2,6,6-pentamethyl-4-piperidinyl)amino]-1,3,5-triazin-2-yl]amino]propyl]-N′,N″-dibutyl-N″,N″-bis(1,2,2,6,6-pentamethyl-4-piperidinyl)-[CHIMASSORB 119],
1,2,3,4-Butanetetracarboxylic acid-β,β,β′,β′- tetramethyl-2,4,8,10-tetraoxaspiro[5.5]undecane-3,9-diethanol copolymer,2,2,6,6-tetramethyl-4-piperidinyl ester [ADK STAB LA 68], and
1,6-Hexanediamine, N,N′-bis(2,2,6,6-tetramethyl-4-piperidinyl)-, polymer with 2,4-dichloro-6-(4-morpholinyl)-1,3,5-triazine [CYASORB UV-3346];
(e) at least one pigment selected from the group consisting of
Pigment Black 7, Pigment Black 11, Pigment Black 12, Pigment Black 26, Pigment Black 27, Pigment Black 28, Pigment Black 30, Pigment Blue 7, Pigment Blue 15.1, Pigment Blue 15.3, Pigment 15:4, Pigment 15:2, Pigment Blue 28, Pigment Blue 29, Pigment Blue 36, Pigment Blue 60, Pigment Brown 11, Pigment Brown 23, Pigment Brown 24, Pigment Brown 33, Pigment Brown 35, Pigment Green 17, Pigment Green 26, Pigment Green 36, Pigment Green 50, Pigment Green 7, Pigment Red 104, Pigment Red 110, Pigment Red 122, Pigment Red 101, Pigment Red 178, Pigment Red 202, Pigment Red 254, Pigment Red 149, Pigment Red 108, Pigment Violet 14, Pigment Violet 15, Pigment Violet 16, Pigment Violet 19, Pigment Violet 23, Pigment Violet 29, Pigment Violet 37, Pigment Violet 47, Pigment Yellow 37, Pigment Violet 48, Pigment Yellow 53, Pigment Yellow 110, Pigment Yellow 119, Pigment Yellow 161, Pigment Yellow 162, Pigment Yellow 163, Pigment Yellow 164, Pigment Yellow 184, Pigment Yellow 199, Pigment Yellow 215, Pigment Yellow 34, Pigment Yellow 35, Chromothal Yellow 382 EOB, Pigment Orange 61, Pigment Orange 20, Pigment White 21, Pigment White 22, Pigment White 4, Pigment White 5, Pigment White 7, and Pigment White 6, and
(f) optionally, carbon black.
